(19) United States
(12) Patent Application Publication
(10) Pub. No.: US 2014/0320662 A1
(43) Pub. Date: Oct. 30, 2014

(54) Systems and Methods for Controlling Cameras at Live Events

(71) Applicants: Roger McNamee, Menlo Park, CA (US); Glenn Evans, Menlo Park, CA (US); Mark Richards Frederick, Sandy, UT (US)

(72) Inventors: Roger McNamee, Menlo Park, CA (US); Glenn Evans, Menlo Park, CA (US); Mark Richards Frederick, Sandy, UT (US)

(73) Assignee: MOONTUNES, INC., Menlo Park, CA (US)

(21) Appl. No.: 14/218,529

(22) Filed: Mar. 18, 2014

Related U.S. Application Data
(60) Provisional application No. 61/793,820, filed on Mar. 15, 2013.

(51) Int. Cl. H04N 7/18

(52) U.S. Cl. CPC H04N 7/181
USPC 348/159

(57) ABSTRACT

Provided is a computer-implemented method in which cameras at a live event can be remotely controlled by a user device having one or more processors and memory storing one or more programs for execution by the one or more processor. The user device obtains a wireless transmission of a camera view of a live event from each of a plurality of video cameras at the live event. At least a subset of views from the plurality of cameras is displayed on the user device. The user device obtains instructions from the user directing movement of a first video camera of the plurality of video cameras. The user instructions are converted into one or more actuator commands and are wirelessly transmitted to the first video camera for changing the camera view of the live event of the first video camera.

### RELATED APPLICATION

This application claims priority to U.S. Provisional Patent Application No. 61/793,820, filed on Mar. 15, 2013, which is hereby incorporated by reference in its entirety.

### TECHNICAL FIELD

The disclosed implementations relate generally to remotely controlling video cameras at a live event via a wireless network.

### BACKGROUND

Broadcasting events live has become increasingly important. For example, a baseball fan may prefer watching a baseball game live on a cable network, rather than viewing a rerun several hours (or sometimes, even days) after the game has finished and its score published. A central goal of the organizers and producers of a live event, such as a concert, is to get the content of the live event distributed to a wide audience. Aside from assuring sufficient financial compensation to make the live event commercially feasible, the most fundamental measure of the success of the live event is how many people participated in, viewed, or listened to the live event. With the advent of the Internet and other avenues for delivering live content, many more people are interested in, and have the ability to conveniently view and participate in live events—whether it be a baseball game, a concert or an academic lecture. The increased interest in live events has also led to an increased interest by those watching the event, and by event organizers, in events that provide a dynamic and unique experience every time. A key element of the viewing experience is the video captured during the event. While the desire to capture exciting footage at an event in theory is attractive, difficulties abound. First, event organizers may not have the resources to hire the cameramen needed to film an event dynamically-changing the positions of the video cameras as the event proceeds to capture exciting footage. Also, because of the size and weight of the average video camera at large events, having a person change the view of a specific video camera during a live event may not be a feasible proposition.

Given the above background, what is needed in the art are systems and methods for remotely controlling video cameras at live events, thus negating the need for human beings to change the views of a given video camera during a live event.

### SUMMARY

It would be advantageous to provide a mechanism and method for allowing a director or event organizer to wirelessly remote control a plurality of video cameras at a live event. The present invention overcomes the limitations and disadvantages described above by providing methods, systems, and computer readable storage mediums for wirelessly connecting to and controlling video cameras at a live event.

The following presents a summary of the invention in order to provide a basic understanding of some of the aspects of the invention. This summary is not an extensive overview of the invention. It is not intended to identify key/critical elements of the invention or to delineate the scope of the invention. Its sole purpose is to present some of the concepts of the invention in a simplified form as a prelude to the more detailed description that is presented later.

Various embodiments of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various embodiments are used

Some embodiments provide a computer-implemented method in which cameras at a live event can be remotely controlled, by a user device having one or more processors and memory storing one or more programs for execution by the one or more processor. The user device obtains a wireless transmission of a camera view of a live event from each of a plurality of video cameras at the live event. At least a subset of views from the plurality of cameras is displayed on the user device. The user device obtains instructions from the user directing movement of a first video camera of the plurality of video cameras. The user instructions are converted into one or more actuator commands and are wirelessly transmitted to the first video camera for changing the camera view of the live event of the first video camera.

Some embodiments provide a system comprising one or more central processing units, CPU(s), for executing programs and also includes memory sorting the programs to be executed by the CPUs. The programs include instructions to perform any of the embodiments of the aforementioned method. Some embodiments of a system also include program instructions to execute the additional options discussed above.

Yet other embodiments provide a computer readable storage medium storing one or more programs configured for execution by a computer. The programs include instructions to perform any of the embodiments of the aforementioned method. Some embodiments of a computer readable storage medium also include program instructions to execute the additional options discussed above.

Thus, these methods, systems, and GUIs provide new, less cumbersome, more efficient ways to remotely control video cameras at a live event.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1A is a block diagram illustrating a system for distributing audio/video feed of live event via a satellite, in accordance with some implementations.

FIG. 1B is a block diagram illustrating a method for wirelessly controlling video cameras at a live event, in accordance with some implementations.

FIG. 2A is a block diagram illustrating an example implementation of a satellite broadcasting system, in accordance with some implementations.

FIG. 2B is a block diagram illustrating an example implementation of a method for wirelessly controlling video cameras at a live event, in accordance with some implementations.

FIG. 3 is a block diagram illustrating an example live HD video streamer, in accordance with some implementations.

FIG. 4 is a block diagram illustrating a satellite uplink device, in accordance with some implementations.

FIG. 5 is a block diagram illustrating a satellite downlink device, in accordance with some implementations.

FIG. 6 is a block diagram illustrating a client device, in accordance with some implementations.

FIG. 7 is a flow chart illustrating a method for distributing audio/video feed of a live event via a satellite, in accordance with some implementations.

FIGS. 8A-8B are flow charts illustrating methods for distributing audio/video feed of a live event via a satellite, in accordance with some implementations.

FIGS. 9A-9B are flow charts illustrating methods for distributing audio/video feed of a live event via a satellite, in accordance with some implementations.

FIGS. 10A-10B are flow charts illustrating methods for wirelessly controlling video cameras at a live event, in accordance with some implementations.

FIG. 11 is a block diagram illustrating a user device, in accordance with some implementations.

FIG. 12 is a block diagram illustrating a camera, in accordance with some implementations.

FIG. 13 is a flow chart illustrating a method for wirelessly controlling cameras at a live event, in accordance with some illustrations.

FIG. 14 is a block diagram illustrating a system for remotely controlling video camera using a computing cloud, in accordance with some implementations.

### DETAILED DESCRIPTION

The present disclosure incorporates by reference, in its entirety, U.S. Patent Application Ser. No. 61/725,421, filed on Nov. 12, 2012, entitled “Systems and methods for communicating a live event to users using the Internet.”

The present disclosure provides systems and methods for controlling cameras at a live event (e.g., a concert, a speech, a rally, a protest, an athletic game, or a contest). Before dealing with the control of video cameras, some details are provided regarding techniques for distributing audio or video feed of a live event via a satellite are provided.

These techniques may significantly increase viewing experience for viewers, and viewership and ratings for content providers (e.g., live performance artists or TV stations).

In some implementations, at a live event (e.g., a rock concert), audio and video data are collected from the event live, using several video cameras, and microphones. In some implementations, the video cameras include camcorders. The audio and video data are then mixed into mixed digital signals and streamed into bitrate streams. In some implementations, the bitrate streams are then transmitted to a geodetic satellite via a mobile VSAT (e.g., mounted on a vehicle). The satellite relays the bitrate streams to teleports located in various geographic locations where viewers may be found. In some implementations, the bitrate streams are then transcoded and delivered to one or more content delivery networks, which further deliver the bitrate streams to client devices, such as tablets, laptops, and smart phones, for user to view or to listen to.

In this way, in situations where (1) neither a cable network connection nor the Internet is available, or (2) performance of an existing cable network connection or Internet connection is inadequate (e.g., with only limited bandwidth or relatively high packet loss)—especially for broadcasting a live event, which may require a high speed connection to avoid delays detectable by a user—content providers would still be able to broadcast an event alive, and thus viewers would also still be able to experience the event as it is happening. This approach is advantageous, because: (i) for viewers, viewing experience is enhanced; and (ii) consequently, for content providers, viewership and profitability are increased.

Additional details of implementations are now described in relation to the figures.

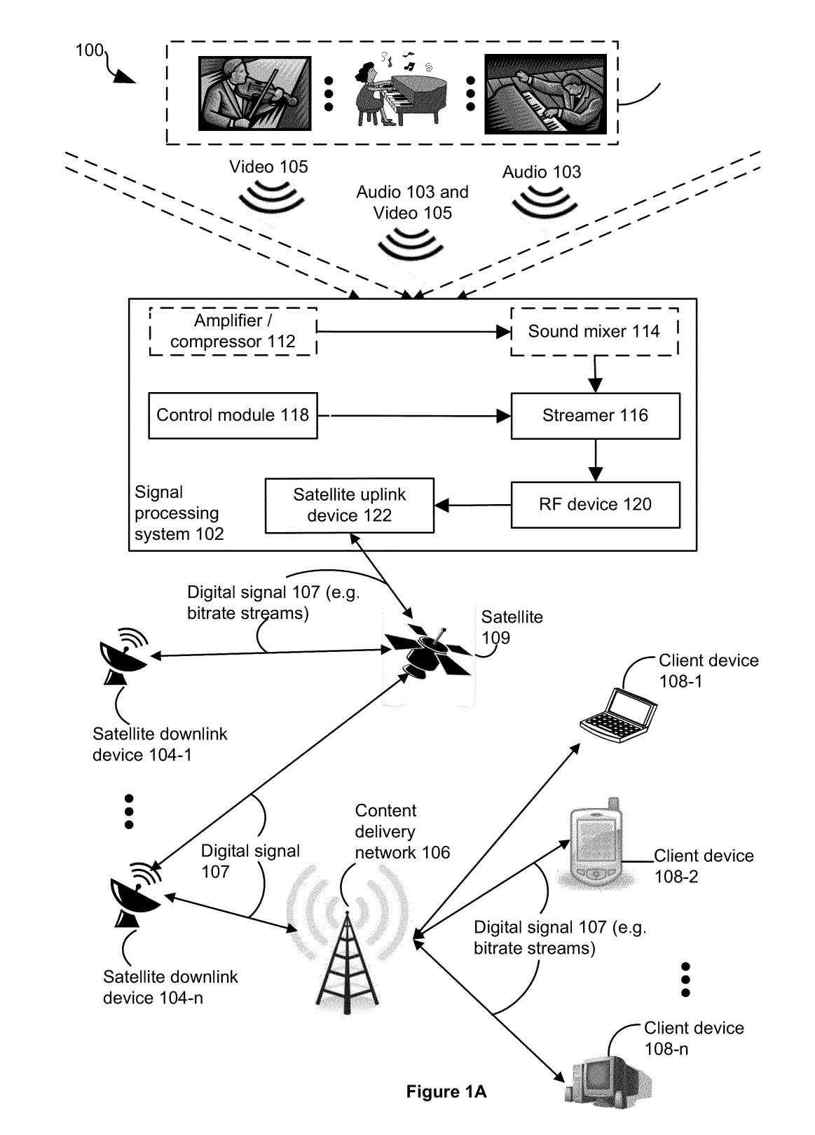

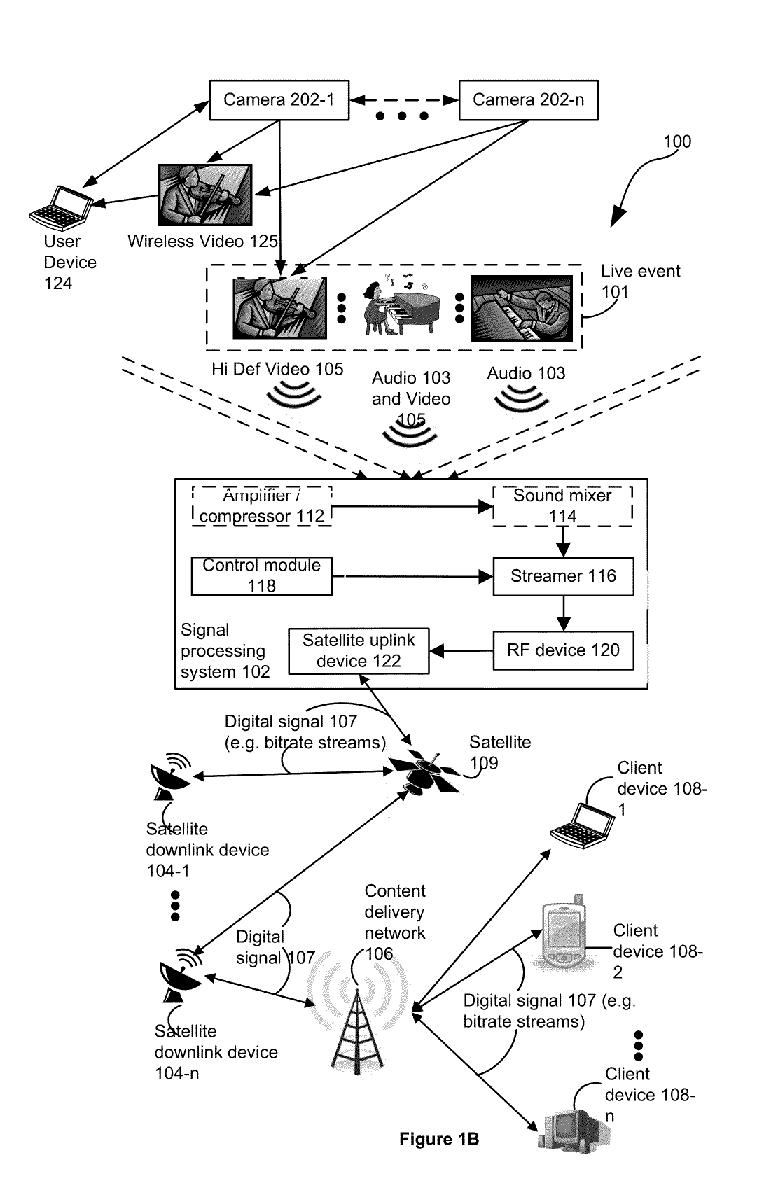

FIG. 1A is a block diagram illustrating a system 100 for distributing audio/video feed of a live event via a satellite, in accordance with some implementations. In some implementations, the system 100 includes a signal processing system 102, a satellite 109, a satellite downlink device 104, a content delivery network 106, and one or more client devices 108.

In some implementations, a predefined number of microphones, or video cameras (or camcorders) are first positioned and configured to record a live event 101 (e.g., a live convert or a press conference).

In some implementations, as the live event is unfolding, the signal processing system 102 obtains video 105 or audio 103, or a portion thereof, from the live event 101 (e.g., a live concert, a live rave party, or a traffic accident). In some implementations, the video 105 is obtained via a camera or camcorder placed at a predefined position relative to the live event (e.g., at a 30 degree angle to a main artist or a primary musical instrument). In other implementations, the video 105 is obtained via a camera or a camcorder placed at a predefined position relative to an output from a display system in use at the live event 101 (e.g., within 3 feet of a LCD screen that is part of a display system at a rock concert).

In some implementations, the video camera/camcorder is a PANASONIC HPX-250, CANON XH A1, CANON XH G1, PANASONIC AG-HVX200, PANASONIC AG-DVX100B, SONY HDR-FX1, CANON XL2, CANON GL1, SONY HANDYCAM HDR-AX2000, PANASONIC AG-HMC150, PANASONIC AVCCAM AG-AC160, SONY HANDYCAM HDR-FX1000, PANASONIC AVCCAM AG-AF100, SONY HVR-V1U, CANON XH A1S, SONY HVR-Z7U, CANON EOS C300, SONY HXR-NX5U, CANON XF100, CANON XL H1S, or CANON XF305 camera. In other implementations, the video camera/camcorder is a CANON GOPRO HERO3, a CANON GOPRO HERO2, CANON GOPRO HERO camera. SONY ACTION, LOGITECH WEBCAM C525, LOGITECH WEBCAM C270, LOGITECH WEBCAM C310, or a LOGITECH WEBCAM C110 camera.

In some implementations, the audio 103 is obtained via a microphone placed at a predefined position relative to the live event (e.g., at a 30 degree angle to a main artist or a primary musical instrument). In other implementations, the audio 103 is obtained via a microphone placed at a predefined position relative to an output from a sound system in use at the live event 101 (e.g., within 3 feet of a high-quality bass/treble speaker or a subwoofer that is part of a sound system at a rock concert). In some implementations, the microphone is a NEUMANN U87 Ai/SETZ, TLM-102, TLM 49, TLM 103, KMS 105 MT, TLM-102 ambient microphone, or a phantom-powered condenser microphone. In some implementations, the microphone is a SHURE SM-57, ROYER R-121, MXL 990, or a BLUE MICROPHONES YETI microphone.

In some implementations, the signal processing system 102 includes an amplifier/compressor 112 (optionally), a sound mixer 114 (optionally), a streamer 116, a control module 118, a RF device 120, and a satellite uplink device 122. In some implementations, the signal processing system 102 obtains audio or video (e.g., the audio 103 or video 105) from a live event, as analog signals, processes these signals, and transmits corresponding digital signals (e.g., bitrate streams) to a satellite, at predefined radio frequencies. In some implementations, the signal processing system 102 is mobile or portable—e.g., mounted on a vehicle, or collapsible and transportable in a trunk case—and can therefore provide on-the-go network connection at live events where an Internet connection or a cable network connection, with satisfactory performance or speed, is unavailable.

In some implementations, the optional amplifier/compressor 112 amplifies or compresses (audio or video) signals received from a microphone or a camera. In some implementations, where two or more (e.g., ambient) microphones or cameras are used to collect the audio or video signals, a matching number of amplifiers/compressors are used, with each microphone or camera having a corresponding amplifier/compressor. In some embodiments, the amplifier/compressor 112 concurrently amplifies/compress audio or video signals in accordance with one or more predefined parameters, such as a predefined compression ratio, an attack time, or a release time.

In some implementations, the optional sound mixer 114 mixes (e.g., ambient) audio or video signals received from one or more microphones or cameras monitoring the live event 101, as well as signals from a sound or video board feed associated with the live event. In some implementations, the optional sound mixer 114 then produces a corresponding mixed signal. In other implementations, the sound mixer 114 mixes amplified or compressed (audio or video) signals received from the amplifier/compressor 112 (rather than directly from microphones or cameras), and produces a corresponding mixed signal.

In some implementations, the streamer 116 receives signals from the sound mixer 114, and produces one or more corresponding bitrate streams. In some implementations, the one or more bitrate streams are stored in one or more audio or video containers (e.g., MP4, 3GP, 3G2). In some implementations, where the sound mixer 114 is not in use, the streamer 116 receives signals from microphones or cameras collecting audio or video from the live event, and produces one or more corresponding bitrate streams.

In some implementations, the control module 118 controls or modifies the operation of the streamer 116, e.g., causing different encoders to be applied to signals received by the streamer, or delays to be inserted insert or removed from the bitrate streams. In some implementations, the control module 118 controls the streamer 116 via a wireless connection (e.g., wifi, bluetooth, radio, or infrared). In some implementations, the control module 118, or a portion thereof, is implemented as a software module (e.g., a smart phone or tablet application) or a hardware module (e.g., a remote control device).

In some implementations, the RF device 120 processes the one or more bitrate streams produced by the streamer 116, and transmits the processed streams as radio signals to the satellite uplink device 122. In some implementations, the radio signals are transmitted at one or more predefined frequency bands (ranges), e.g., 1-2 GHz, 2-4 GHz, 4-8 GHz, 8-12.5 GHz, 12.5 to 18 GHz, 18 to 26.5 GHz, and 26.5 to 40 GHz. In some implementations, the satellite uplink device 122 and the RF device 120 are wirelessly connected to each other. In some implementations, the RF device 120 is located on a floor, e.g., an elevate floor, of a building and the satellite uplink device 122 is located on the street near the building, in a parking garage near the building, or in a parking lot, alley, or yard near the building.

In some implementations, the satellite uplink device 122 locates a predefined satellite (e.g., using appropriate authorization credentials), and transmits the radio signals generated by the RF device 120 to the predefined satellite. In some implementations, the satellite uplink device 122 transmits digital signals 107, as opposed to analog signals, to the satellite 109.

In some implementations, the satellite 109 is a satellite owned or rented by the live event organizer. In some implementations, the satellite 109 is selected based on one or more predefined criteria (e.g., processing power, bandwidth, location, rental contract, pricing, or ownership). In some implementations, the satellite 109 is a geodetic satellite.

In some implementations, the satellite 109 relays the received radio signals to one or more satellite downlink devices located in one or more target areas. In other implementations, the satellite 109, acting as an intermediary, relays the received radio signals to one or more other satellites, which then deliver the radio signal to the one or more satellite downlink devices.

In some implementations, the one or more satellite downlink devices (e.g., satellite downlink devices 104-1 . . . 104-n) are determined based on a predefined set of criteria, such as potential viewership, predicted profitability, geographical location, population density in a target area, and processing power or ownership of a satellite downlink device. For example, to maintain a threshold performance level (e.g., to avoid no user-observable or -detectable delay on a client device), the satellite connects to at least 5 downlink devices in a highly-populated area, such as New York City, New York, where viewer demand is high. For another example, to maintain the threshold performance level, the satellite connects with high performance satellites but forgoes connections with low performance satellites.

In some implementations, the satellite downlink device 104 processes (e.g., transcodes) the digital signals 107 received from the satellite 109, and transmits the processed (e.g., transcoded) signals to a content delivery network 106. In some implementations, a satellite downlink device includes a teleport. In other implementations, a satellite downlink device includes an XM satellite radio receiver.

In some implementations, the satellite downlink device is stationed at a predefined location. In other implementations, like the signal processing system 102, the satellite downlink device is also mobile (e.g., mounted on a vehicle, such as a recreational vehicle or a pickup truck, or a mobile structure, such as a mobile residence or a transportable trunk case). In other implementations, the satellite downlink device is built into a vehicle's sound system (e.g., part of a stereo sound system) or into a handheld device (e.g., an XM satellite hand-held receiver).

In some implementations, the content delivery network 106 further delivers with high quality (e.g., high definition) the digital signals received from the satellite downlink device 104 to one or more client devices 108. In some implementations, the content delivery network 106 includes a large distributed system of data servers located in multiple data centers on the Internet. In some implementations, the content delivery network 106 is configured to deliver to end-users (e.g., viewers) media content, with high availability and high performance. In some implementations, the owner of the content delivery network 106 and the owner of the satellite 109 share a predefined relationship (e.g., contractual, business, or organizational). In some implementations, the content delivery network 106 is owned by ATT, VERIZON, BELL, AMAZON, AKAMAI TECHNOLOGIES, EDGECAST NETWORKS, LEVEL 3 COMMUNICATIONS, or LIMELIGHT NETWORKS. In some implementations, the content delivery network 106 optionally includes the Internet, one or more local area networks (LANs), one or more wide area networks (WANs), other types of networks, or a combination of such networks.

In some implementations, the one or more client devices 108 include consumer electronics capable of playing media content, such as a smart phone, a tablet, a computer, a laptop, a desktop, a display, a TV, and a connected TV (a GOOGLE TV or an APPLE TV device).

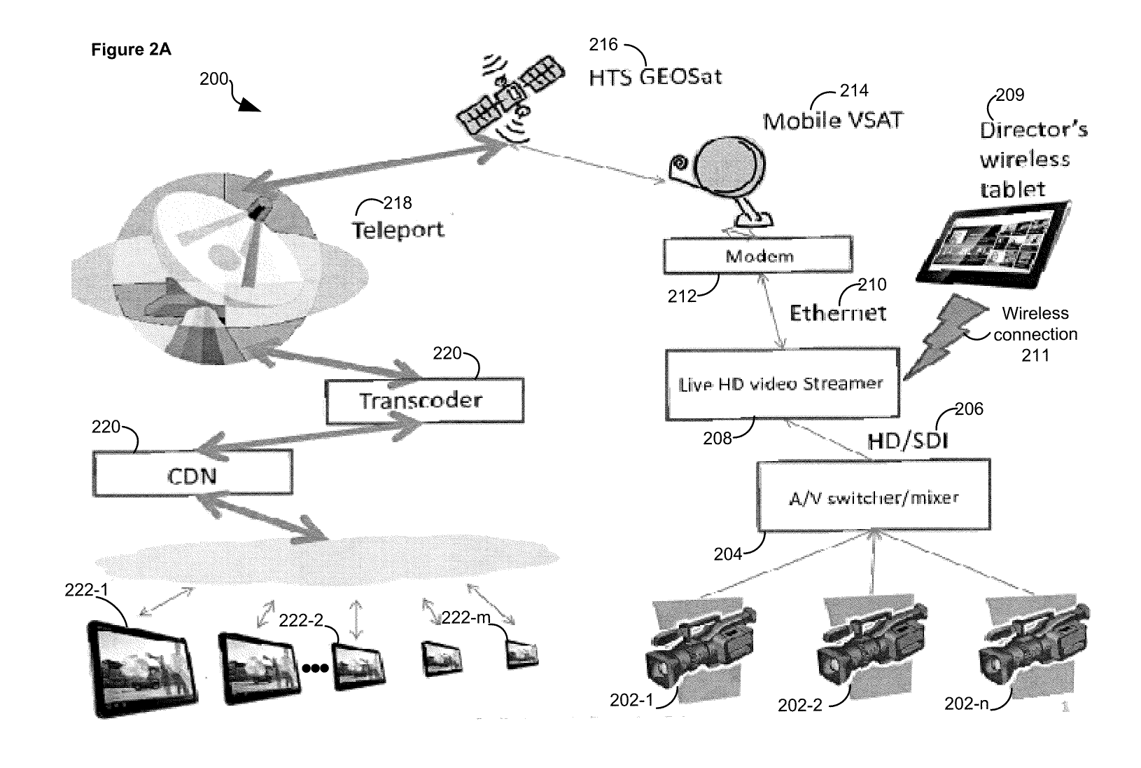

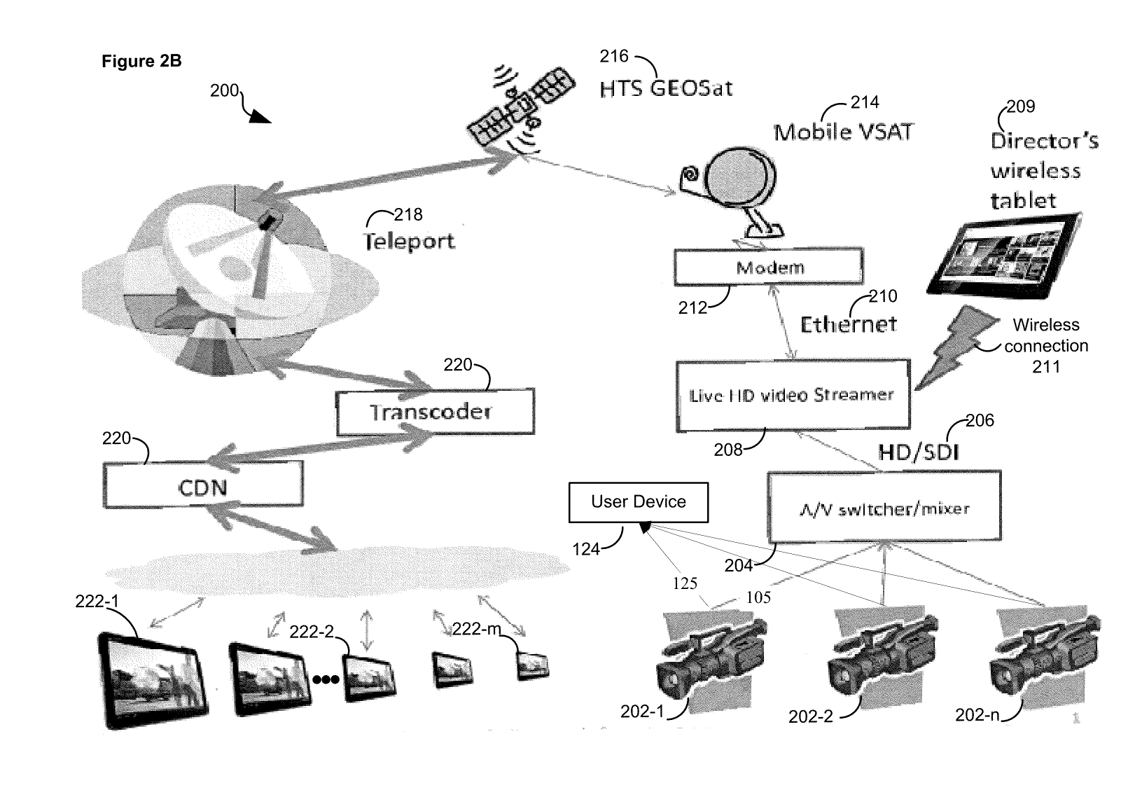

FIG. 2A is a block diagram illustrating an example implementation of a satellite broadcasting system, in accordance with some implementations.

In some implementations, as shown in FIG. 2A, audio or video data, from a live event, are collected using one or more (e.g., high definition) camcorders 202-1, 202-2 . . . 202-n (e.g., mobile or stationed at various locations in relation to the live event). In some implementations, the audio or video data are then transmitted to an A/V switcher or mixer 204, using wired (e.g., HDMI cable) or wireless (e.g., wifi) connections so as increase the mobility of the camcorders during the live event, thereby providing a more comprehensive reporting of the live event.

In some implementations, the A/V switcher or mixer 204 transmits the audio or video data to a live HD video/audio streamer 208, as digital signals, via a high definition serial digital interface (“HD-SDI”) connection 206, a HDMI connection, or a cable connection. In some implementations, the A/V switcher or mixer 204 includes the amplifier/compressor 112 or the sound mixer 114 (shown in FIG. 1A).

In some implementations, the live HD video/audio streamer 208 produces one or more bitrate streams, using signals received from the A/V switcher or mixer 204, and transmits the bitrate streams to a modem 212, via an Ethernet connection 210. In some implementations, the bitrate streams are produced in accordance with communications (e.g., control signals) received from a control device. In some implementations, the control device is a mobile computing device (e.g., a tablet) equipped with appropriate software packages and processing power. In some implementations, the control device connects with the live HD video/audio streamer 208 via a wireless connection (e.g., so as to increase mobility of the control device, or a user thereof). In some implementations, a person in charge of broadcasting the live event, such as a broadcasting director, controls the control device (and thus the operation of the live HD video/audio streamer 208) for the duration of the event.

In some implementations, the modem 212 further transmits the digital signals to a mobile VSAT 214. In some implementations, the mobile VSAT 212 is mounted on a vehicle (e.g., a broadcasting vehicle). In some implementations, the mobile VSAT is capable of being folded or collapsed into and transported within a trunk case like container (e.g., to increase the mobility of the VSAT). In some implementations, two or more mobile VSATs are used concurrently, to provide a more comprehensive report of the live event. In some implementations, where several mobile VSATs are used concurrently, one mobile VSAT broadcasts one part of a live event at one location, and another mobile VSAT broadcasts another part of the same event at a different location. For example, one mobile VSAT is used to broadcast, on scene, a roadside traffic accident; while another mobile VSAT is used to broadcast, at a nearby hospital, medical condition of injured occupants.

In some implementations, the mobile VSAT 214 locates a satellite 216, such as a high throughput geo-stationary satellite (“HTS GEOSat” or “GEOSat”), establishes a connection with the GEOSat (e.g., using appropriate credentials), and transmits the digital signals to the GEOSat.

In some implementations, the HTS GEOSat 216 further transmits (e.g., relays) the digital signals to one or more teleports 218 (or hand-held satellite signal receivers) located in different geographical areas. In some implementations, the HTS GEOSat 216 is a satellite whose bandwidth (e.g., transmission speed during a particular time period) or a portion thereof is rented from or owned by DISH NETWORK, HUGHES NETWORK, DIRECTTV NETWORK or TELESAT Canada.

In some implementations, the one or more teleports 216 transmit the digital radio signals to a transcoder 220, which performs one or more digital-to-digital transcoding operations (lossy or lossless) before delivering the transcoded digital signals to a content delivery network (“CDN”) 220. In some implementations, the transcoding operations are determined based on one or more performance criteria. For example, when transmission speed is of essence, trancoding operations configured to produce a predefined degree of compression are performed; for another example, when media content quality is of essence, only lossless trancoding operations are performed.

In some implementations, the CDN 220 transmits the digital signals to one or more client devices 222-1, 222-2 . . . , and 222-n (e.g., smart phone, tablets, or smart TV devices), where media content corresponding to the live event is displayed to a user in real time or within a threshold amount of delay (e.g., less than 300 milliseconds) from the occurrence of the live event.

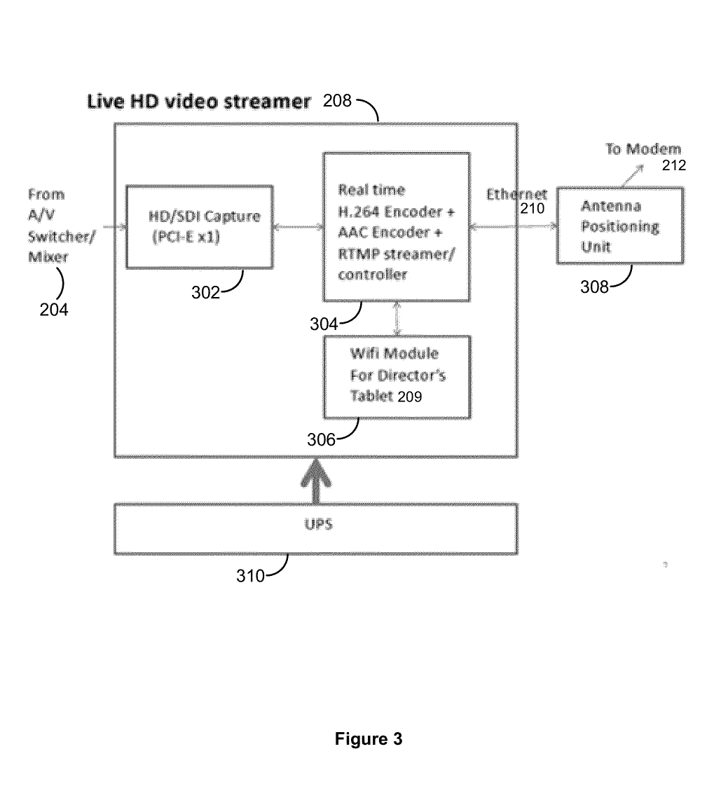

FIG. 3 is a block diagram illustrating an example live HD video streamer 208, in accordance with some implementations.

In some implementations, the live HD video stream 208 receives input from the A/V switcher/mixer 204 (as shown in FIG. 1A) and a uninterrupted power supply (“UPS”) 310, and outputs digital signals to the Modem 212 or an antenna position unit connected thereto. In some implementations, digital signals received from the A/V switcher/mixer 204 are first processed by a HD-SDI capture unit 302, which is configured to capture a predefined number of HD-SDI link sources simultaneously and support a variety of predefined formats. In some implementations, the HD-SDI capture unit 302 is a PCI-E x1 compatible device.

In some implementations, output from the HD-SDI capture unit 302 is transmitted to a controller 304, which includes a real time H.264 encoder, AAC encoder or an RTMP streamer.

In some implementations, the controller 304 processes the input from the HD-SDI capture unit 302 in accordance with communications (e.g., user input by an event or broadcasting director) received from the UPS 310 (e.g., via a wife module 209 resident in the streamer 208 and connected with the controller 304).

In some implementations, the signals processed by the controller 304 are transmitted, via the Ethernet 210, to the antenna position unit 308, and then to the modem 212.

In some implementations, the antenna position unit 308 adjusts positions or directions of a satellite uplink device, or a portion thereof (e.g., a satellite dish), so as to locate and connect with a desired satellite, to which digital signals associated with the live event are then transmitted.

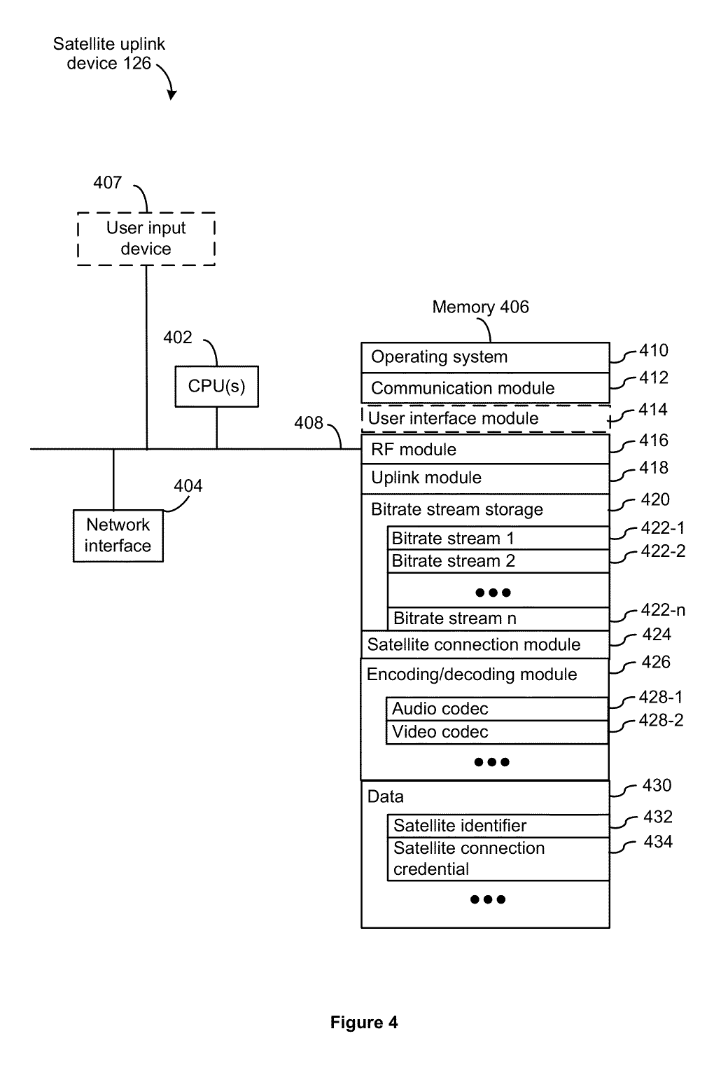

FIG. 4 is a block diagram illustrating a satellite uplink device, in accordance with some implementations.

The satellite uplink device 126, in some implementations, includes one or more processing units CPU(s) 402 (also herein referred to as processors), one or more network interfaces 404, memory 406, optionally a user input device 407 (e.g., a keyboard, a mouse, a touchpad, or a touchscreen), and one or more communication buses 408 for interconnecting these components. The communication buses 408 optionally include circuitry (sometimes called a chipset) that interconnects and controls communications between system components. The memory 406 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 406 optionally includes one or more storage devices remotely located from the CPU(s) 402. The memory 406, or alternatively the non-volatile memory device(s) within the memory 406, comprises a non-transitory computer readable storage medium. In some implementations, the memory 406 or alternatively the non-transitory computer readable storage medium stores the following programs, modules and data structures, or a subset thereof:
an operating system 410, which includes procedures for handling various basic system services and for performing hardware dependent tasks;
a network communication module (or instructions) 412 for connecting the satellite uplink device 126 with other devices (e.g., the satellite 109 or the RF device 120) via one or more network interfaces 404 (wired or wireless);
optionally, a user interface module 414 for enabling a user to interact with the satellite uplink device, such as establishing or adjusting a connection between the satellite uplink device and the satellite, e.g., using appropriate login credentials or satellite location information;
optionally, an RF module 416 for converting incoming signals (e.g., from the streamer 116) into radio frequency signals; in some implementations, the RF module 416, or a portion thereof, is implemented in hardware (e.g., a chip set) to provide more processing power or speed;
an uplink module 418 for processing and transmitting RF signals to one or more satellite, in accordance with predefined criteria;
a bitrate stream storage 420, stored on the satellite uplink device 126, which includes:
   bitrate stream n 422-n for including digital signals awaiting transmission to the satellite;
a satellite connection module 424 for establishing a new connection or adjusting an existing connection with a satellite (e.g., the satellite 109);
an encoding/decoding module 426 for encoding or decoding RF signals before they are transmitted to a satellite, using one or more audio/video codecs (e.g., 428-1 and 428-2); and
data 430, stored on the satellite uplink device 126, which include:
   a satellite identifier 432, which uniquely identifies a satellite among several available satellite; and
   satellite connection credential 434, e.g., a connection code, or a user name and corresponding password, for establishing or maintaining a connection with one or more satellites.

In some implementations, the satellite uplink device 126 connects concurrently with two or more satellites. In some implementations, transmission load is balanced among the two or more satellites. In some implementations, the same bitrate streams are sent to several satellites with different target area coverage or performance.

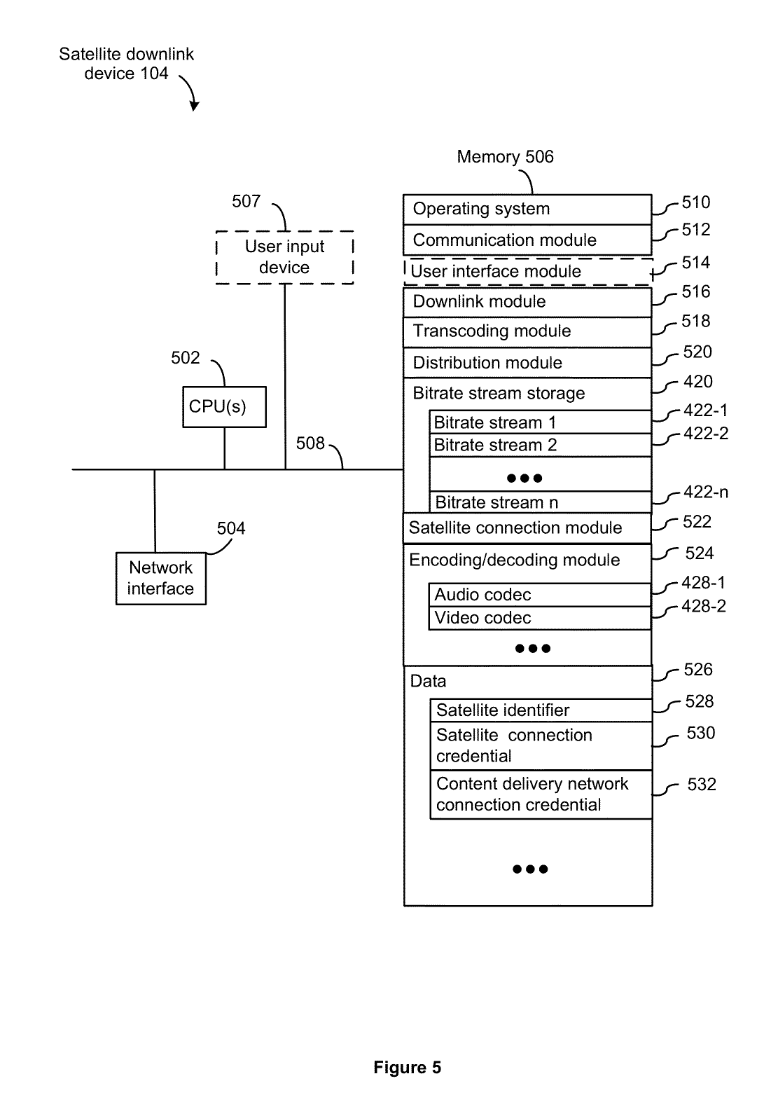

FIG. 5 is a block diagram illustrating a satellite downlink device, in accordance with some implementations.

The satellite downlink device 104, in some implementations, includes one or more processing units CPU(s) 502 (also herein referred to as processors), one or more network interfaces 504, memory 506, optionally a user input device 507 (e.g., a keyboard, a mouse, a touchpad, or a touchscreen), and one or more communication buses 508 for interconnecting these components. The communication buses 508 optionally include circuitry (sometimes called a chipset) that interconnects and controls communications between system components. The memory 506 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 506 optionally includes one or more storage devices remotely located from the CPU(s) 502. The memory 506, or alternatively the non-volatile memory device(s) within the memory 506, comprises a non-transitory computer readable storage medium. In some implementations, the memory 506 or alternatively the non-transitory computer readable storage medium stores the following programs, modules and data structures, or a subset thereof:
an operating system 510, which includes procedures for handling various basic system services and for performing hardware dependent tasks;
a network communication module (or instructions) 512 for connecting the satellite downlink device 104 with other devices (e.g., the satellite 109 or the content delivery network 106) via one or more network interfaces 504 (wired or wireless);
optionally, a user interface module 514 for enabling a user to interact with the satellite downlink device, such as establishing or adjusting a connection between the satellite downlink device 126 and the satellite 109, e.g., using appropriate login credentials, satellite location information;
a downlink module 516 for obtaining incoming signals (e.g., bitrate streams) from a satellite, and processing the incoming signals in accordance with predefined processing criteria;
a transcoding module 518, for applying one or more iterations of transcoding to the incoming signals;
a distribution module 520 for distributing the (optionally transcoded) incoming signals to one or more identified content networks;
a bitrate stream storage 420, stored on the satellite downlink device 104, which include:
   bitrate stream n 422-n (or processed signals corresponding thereto), for including digital signals received from a satellite (e.g., the satellite 109);
a satellite connection module 522 for establishing a new connection or adjusting an existing connection with a satellite (e.g., the satellite 109);
an encoding/decoding module 524 for encoding or decoding incoming digital signals (e.g., bitrate streams) before they are transmitted to a content delivery network, using one or more audio/video codecs (e.g., 428-1 and 428-2); and
data 526, stored on the satellite downlink device 104, which include:
   a satellite identifier 528, which uniquely identifies a satellite among several satellite;
   satellite connection credential 530, e.g., a connection code, or a user name and corresponding password, for establishing or maintaining a connection with one or more satellites; and
   content delivery network connection credential 532, e.g., a connection code, or a user name and corresponding password, for establishing or maintaining a connection with one or more content delivery networks.

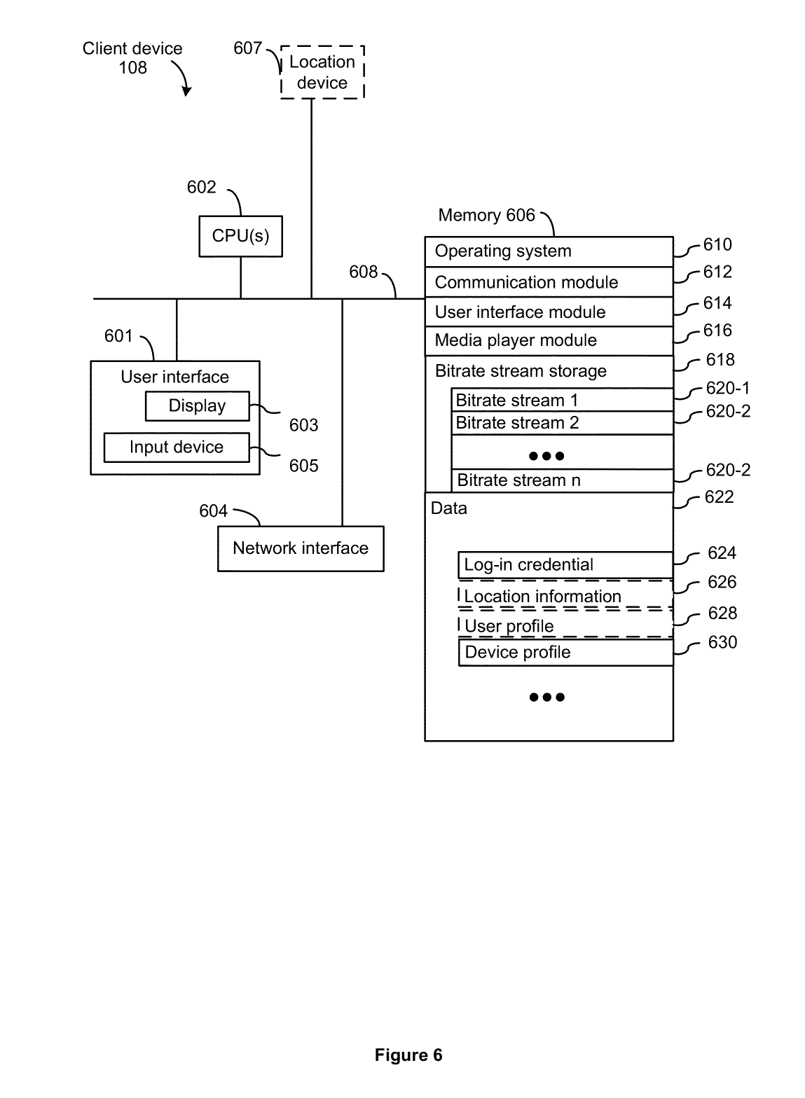

FIG. 6 is a block diagram illustrating a client device, in accordance with some implementations.

The client device 108, in some implementations, includes a user interface 601, one or more processing units CPU(s) 602 (also herein referred to as processors), one or more network interfaces 604, memory 606, optionally a location device 607 (e.g., a GPS device), and one or more communication buses 608 for interconnecting these components. The user interface 601 includes a display 603 (e.g., a LCD or a touchscreen), and an input device 605 (e.g., a keyboard, a mouse, a touchpad, or a touchscreen). The communication buses 608 optionally include circuitry (sometimes called a chipset) that interconnects and controls communications between system components. The memory 606 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 606 optionally includes one or more storage devices remotely located from the CPU(s) 602. The memory 606, or alternatively the non-volatile memory device(s) within the memory 606, comprises a non-transitory computer readable storage medium. In some implementations, the memory 606 or alternatively the non-transitory computer readable storage medium stores the following programs, modules and data structures, or a subset thereof:
an operating system 610, which includes procedures for handling various basic system services and for performing hardware dependent tasks;
a network communication module (or instructions) 612 for connecting the client device 108 with other devices (e.g., the content delivery network 106 or other client devices 102) via one or more network interfaces 604 (wired or wireless);
a user interface module 614 for enabling a user to interact with the client device (e.g., to receive media content from different content delivery networks, or to display or modify the received media content);
a media player module 616 (e.g., MICROSOFT media player or APPLE QUICK TIME) for processing media content (or corresponding signals or bitrate streams) received from content delivery network for user consumption (e.g., visually or audibly);
a bitrate stream storage 618, stored on the client device 108, which includes:
   bitrate stream n 620-n (or processed signals corresponding thereto), for including signals received from to the content delivery network; and
data 622, stored on the client device 108, which include:
   log-in credential 624 for authenticating a user of (e.g., logging into) the client device;
   optionally, location information 626 for indicating location of the client device or a user thereof;
   optionally, a user profile 628 for including, with express user permission, user demographics (e.g., race, profession, income level, or educational level), or user viewing activity, history, or preference; and
   a device profile 630 for including client device configuration information (e.g., display resolutions supported or enabled, graphical or general processing power equipped, operating system version, or memory capacity).

In some implementations, the location device 607 identifies, with a predefined level of accuracy, location of the client device 108, which can be used, in many situations, to infer location of a user of the client device (e.g., the user who has an active login on the client device).

Although FIGS. 4 and 5 show a “satellite downlink device 122” and a “satellite uplink device 104,” respectively, FIGS. 4 and 5 are intended more as functional description of the various features which may be present in satellite systems than as a structural schematic of the implementations described herein. In practice, and as recognized by those of ordinary skill in the art, items shown separately could be combined and some items could be separated.

In some implementations, one or more of the above identified elements are stored in one or more of the previously mentioned memory devices and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memories 406, 506, 606 optionally store a subset of the modules and data structures identified above. Furthermore, the memories 406, 506, 606 optionally store additional modules and data structures not described above.

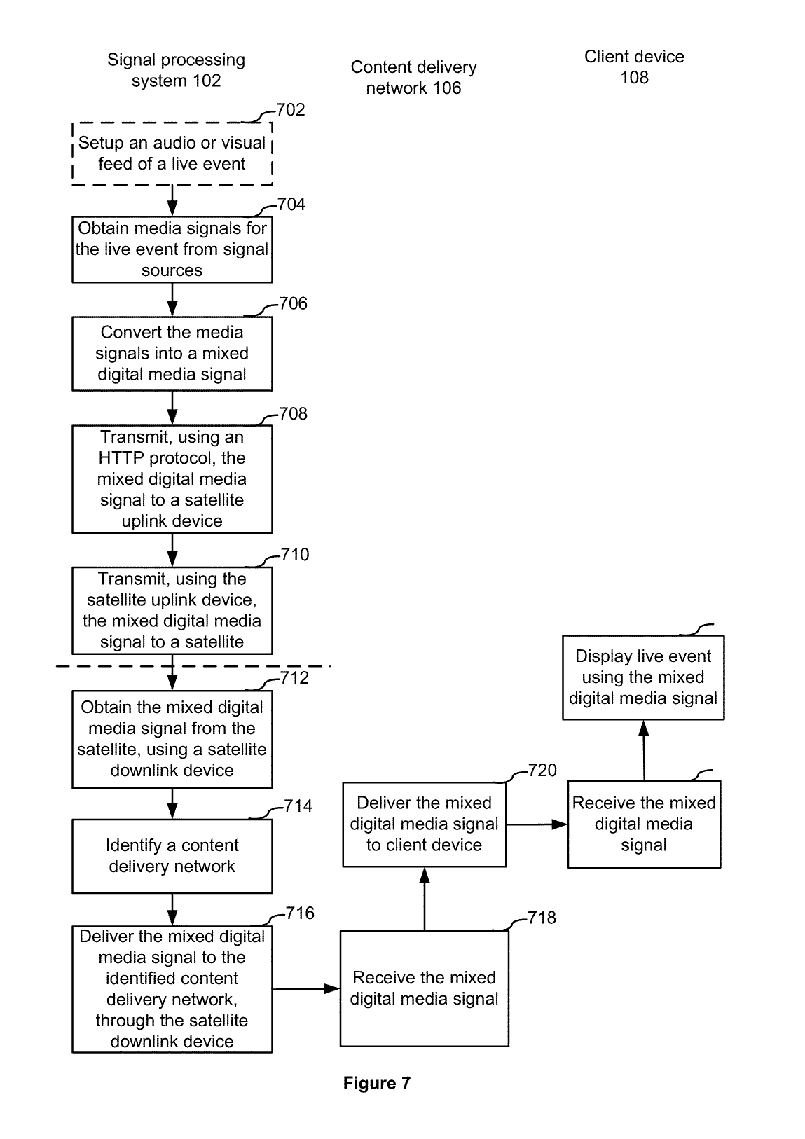

FIG. 7 is a flow chart illustrating a method 700, implemented at a computer system, for distributing audio/video feed of live event via satellite, in accordance with some implementations.

In some implementations, an audio or visual feed is optionally first set up at a live event (702), e.g., by positioning one or more microphones or HD cameras at predefined locations relative to the live event. In some implementations, a computer system then obtains (704) media signals for the live event from one or more signal sources (e.g., the microphones or cameras). In some implementations, the media signals are collected as analog signals.

In some implementations, the computer system then converts (706) the (e.g., analog) media signals collected from the signal sources, into a mixed digital media signal, which is then transmitted (708) using a network protocol (e.g., an HTTP protocol) (e.g., through a LAN or an Intranet) to a satellite uplink device. In some implementations, the media signals are mixed using a mixer and then converted, using a streamer (e.g., the streamer 116 in FIG. 1A), into one or more bitrate streams.

In some implementations, the mixed digital media signal is transmitted to the satellite uplink device through a wireless connection (e.g., a wife, Bluetooth, infrared connection). In some implementations, the mixed digital media signal is generated using a device (e.g., the streamer 208) placed in an indoor environment (on a floor, e.g., an elevate floor, of a building, or near a stage), and the satellite uplink device 122 is located on the street near the building, in a parking garage near the building, in a parking lot, alley, or yard near the building, on the roof of a building, a mobile broadcasting vehicle, a large trunk truck, or a trailer truck.

In some implementations, the distance between the streamer 208 and the satellite uplink device is within a predefined threshold distance, so as to maintain signal quality. In some implementations, the distance between the streamer 208 and the satellite uplink device is determined in accordance with capacities associated with the stream or the uplink device. In some implementations, the distance is within 20 meters, 50 meters, 100 meters, 200 meters, or 500 meters.

In some implementations, the wireless connection is implemented in IEEE 802.11 standards, such as 802.11a, 802.11b, 802.11g, 802.11-2007, 802.11n, 802.11n-2012, 802.11ac, and 802.11ad. In some implementations, the wireless connection is implemented in Bluetooth v1.0, v1.0B, v1.1, v1.2, v2.0+EDR, v2.1+EDR, v3.0+HS, or v4.0.

In some implementations, the computer system transmits (710), using one or more satellite uplink devices (e.g., a mobile VSAT), the mixed digital signals at one or more RF frequency bands to a satellite.

In some implementations, the computer system, using one or more satellite downlink devices, such as a teleport or a hand-held satellite signal receiver, obtains (712) the mixed digital signal from the satellite.

In some implementations, the computer system identifies (714) a content delivery network, among several available content delivery networks, in accordance with one or more predefined criteria. In some implementations, the one or more predefined criteria include one of: performance, bandwidth, quality, pricing, signal coverage, and location.

In some implementations, the computer system delivers (716) the mixed digital media signal (or the bitrate streams) to the identified content delivery network, through the satellite downlink device.

In some implementations, after the mixed digital media signal is delivered, the content delivery network receives (718), and further delivers (720), the mixed media signal, to one or more client devices for user consumption (audibly or visually).

In some implementations, one of the one or more client devices receives (722) the mixed media signal from the content delivery network. In some implementations, media content corresponding to the live event is displayed (720), within a threshold amount of delay (e.g., no more than 75 milliseconds), on the client device. In some implementations, media content is displayed using a predefined resolution (e.g., HD or 1080p), so as to enhance viewing experience.

In some implementations, a user of a client device optionally executes one or more software applications (such as a TWO like application), so as to capture or save a copy of the media content for later consumption (e.g., a record and play-later feature).

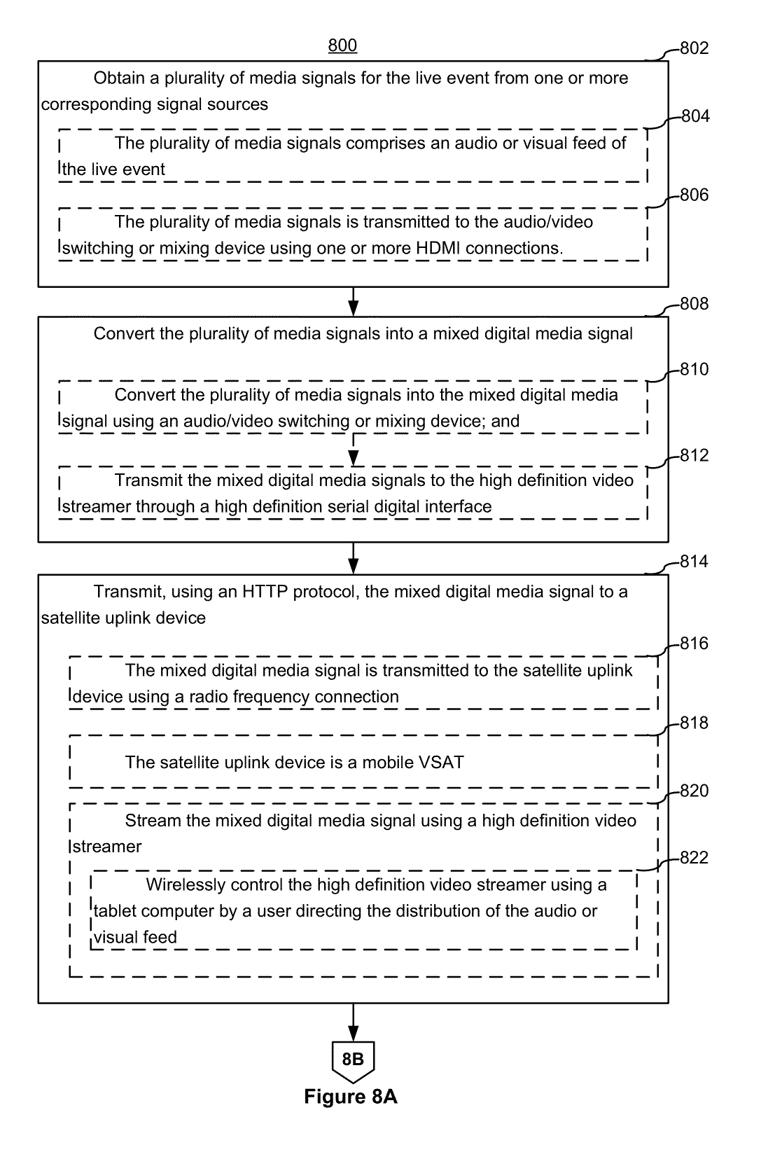

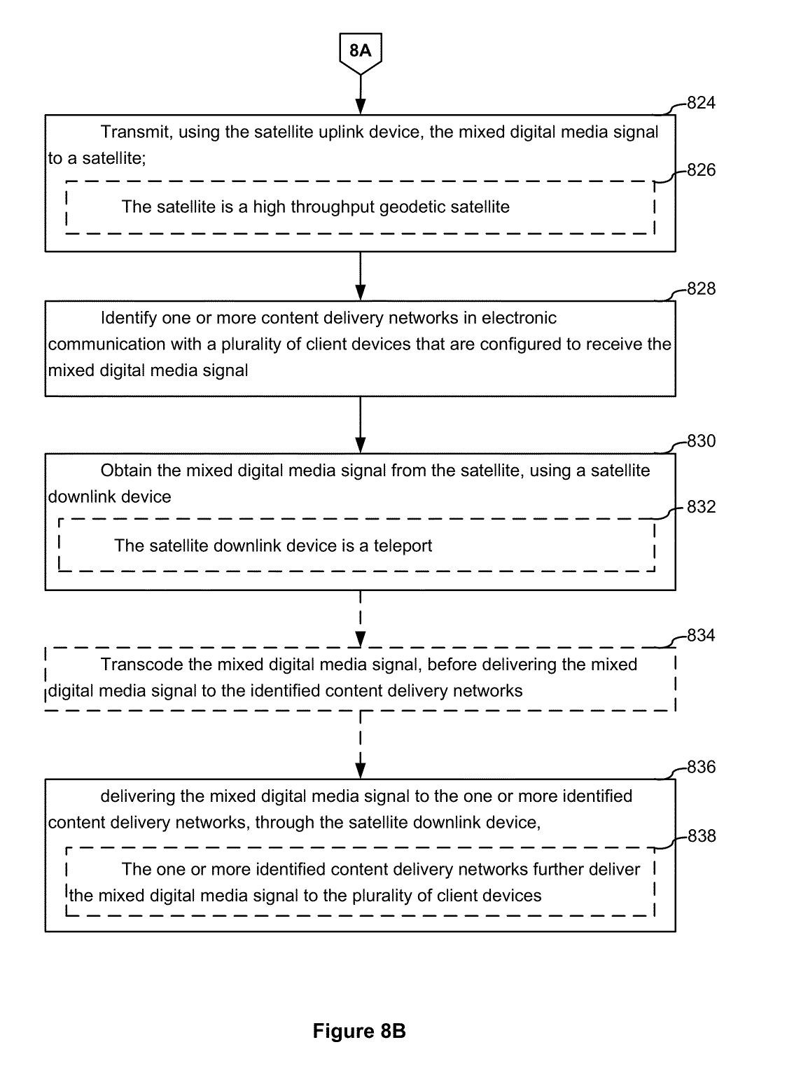

FIGS. 8A-8B are flow charts illustrating a method 800, implemented at a computer system including a satellite uplink device, a satellite, or a satellite downlink device, for distributing audio/video feed of live event via a satellite, in accordance with some implementations.

In some implementations, at a computer system, a plurality of media signals for the live event is obtained (802) from one or more signal sources. In some implementations, a signal source in the one or more signal sources is a HD video camera or a high quality microphone. In some implementations, the plurality of media signals comprises an audio or visual feed of the live event (804). In some implementations, the plurality of media signals includes analog signals collected using microphones, camcorders, or HD cameras, from the live event.

In some implementations, the plurality of media signals is then transmitted to an audio/video switching or mixing device using one or more HDMI connections (806). For example, in some implementations, analog signals collected from microphones or camera are transmitted to the AN switcher/mixer 104 or the HD video streamer 108 shown in FIG. 2A, via one or more HDMI cables, e.g., so as to preserve signal quality.

In some implementations, the plurality of media signals is converted (808) into a mixed digital media signal. In some implementations, the plurality of media signals is first converted (810) into a mixed digital media signal using the sounder mixer 114 or the streamer 116 shown in FIG. 1A, or any analog/digital signal conversion device; the mixed digital media signal is, in turn, transmitted (812) to the high definition video streamer (e.g., the live HD video streamer 208 shown in FIG. 2A) through a high definition serial digital interface. Converting analog signals to digital signals is advantageous in many situations (e.g., where preserving signal quality is important). Digital signals are less susceptible to noise or interference than analog signals.

In some implementations, the mixed digital media signal is further transmitted (814), using a network protocol (e.g., an HTTP protocol), to a satellite uplink device. In some implementations, the satellite uplink device is mobile, e.g., mounted on a vehicle or a portable structure or container within predefined height, width, or weight measurements. In some implementations, the satellite uplink device is mobile VSAT (818). In some implementations, the satellite uplink device includes a satellite dish for establish a connection with a satellite.

In some implementations, transmitting, using the HTTP protocol, the mixed digital media signal to the satellite uplink device includes streaming the mixed digital media signal using a high definition video streamer (820), e.g., the streamer 116 in FIG. 1A. In some implementations, the high definition video streamer is controlled (822), via wired or wireless connections, using a portable computer (e.g., an APPLE IPAD or IPHONE or a GOOGLE NEXUS phone or tablet) by a user (e.g., an event director) directing the distribution of the audio or visual feed. In some implementations, wirelessly controlling the streamer is advantageous: The event director is afforded more mobility while directing a live event, such as a live street performance.

In some implementations, the mixed digital media signal is then transmitted (824), using the satellite uplink device, to a predefined satellite. In some implementations, the satellite is a high throughput geostationary satellite (826), so as to provide high speed connections and thus minimize delays between signal sources at the live event and client devices on which media content are displayed. In some implementations, the mixed digital media signal is transmitted to the satellite using a radio frequency connection (e.g., at predefined frequency) (816).

In some implementations, the mixed digital media signal is obtained (830) from the satellite, using a satellite downlink device. In some implementations, the satellite downlink device is a teleport (832).

In some implementations, the mixed digital media signal is optionally transcoded (834), before being delivered to a content delivery network. In some implementations, the transcoding, a lossy or lossless process, includes a digital-to-digital conversion of signals (e.g., bitrate streams) from encoding format to another (e.g., from MPEG I to MPEG IV). In some implementations, the transcoding includes converting digital signals received from the live event to a format compatible with (i.e., acceptable to) client devices, where media content are displayed to a user. In some implementations, the transcoding process is advantageous, as it allows digital signals to be encoded in a format (e.g., low compression) suitable for transmission by a satellite, and corresponding media content in a different format (e.g., high compression) suitable for delivery to a client device, such as a smart phone, on which storage space is sometimes limited.

In some implementations, one or more content delivery networks in electronic communication with a plurality of client devices are identified (828), where the identified content delivery networks are configured to receive and process the mixed digital media signal.

In some implementations, the mixed digital media signal is then delivered (836) to the one or more identified content delivery networks, through the satellite downlink device.

In some implementations, the one or more identified content delivery networks are configured to deliver (838) the mixed digital media signal to one or more client devices. In some implementations, the content delivery process discussed above is subscription based (e.g., a client device must be an authorized subscriber, in order to receive media content (or the mixed digital media signal) from a content delivery network).

In some implementations, a client device in the plurality of client devices is a tablet computer, a smart phone, a desktop computer, a laptop commuter, a TV, or a portable media player. In some implementations, two client devices in the plurality of client devices are associated with different display resolutions, e.g., a low-resolution cell phone, a medium-resolution tablet computer, and a high-resolution connected TV. In some situations, delivering digital media signals to client devices with different display resolutions is advantageous; as it allows media content to be viewed in a manner best suited a user. For example, a user with high bandwidth (e.g., cable connection) may prefer high-resolution media content; while a user with limited bandwidth (e.g., dial-up connection) may prefer low resolution media content.

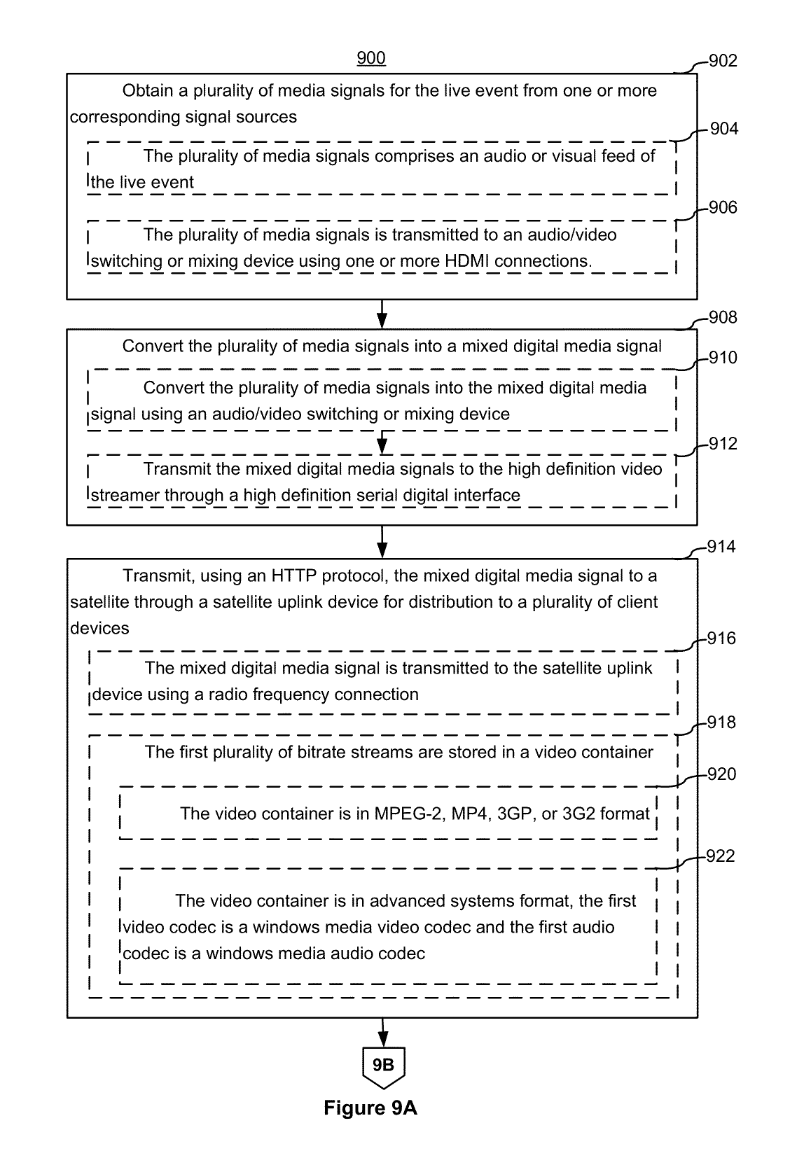

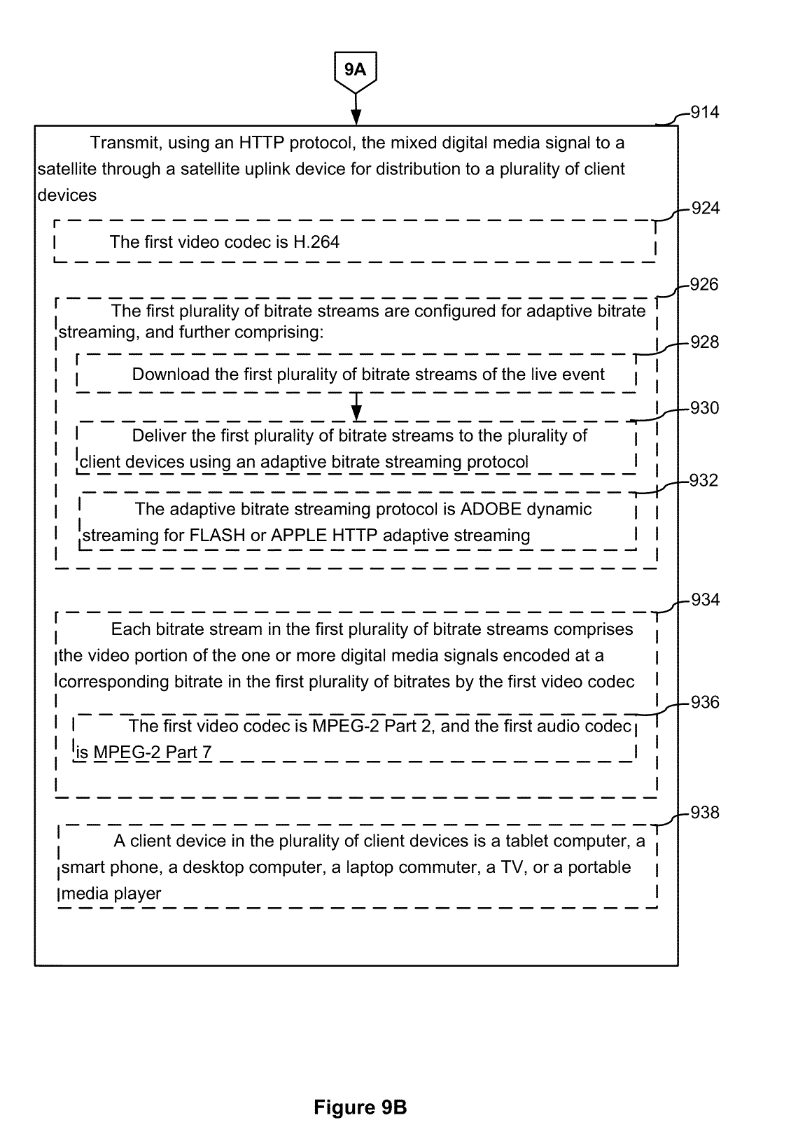

FIGS. 9A-9B are flow charts illustrating a method 900 (e.g., implemented at a computer system) for distributing audio/video feed of a live event via a satellite, in accordance with some implementations.

In some implementations, a plurality of media signals for the live event is obtained (902) from one or more signal sources. In some implementations, the plurality of media signals comprises an audio or visual feed of the live event (904). In some implementations, the one or more signal sources include high quality microphones or HD cameras or camcorders.

In some implementations, the plurality of media signals is transmitted to an audio/video switching or mixing device (e.g., the sound mixer 114 in FIG. 1A) using one or more HDMI connections (906), so as to avoid data loss and to preserve signal quality. For example, in some implementations, analog signals collected from high quality microphones or HD camcorders are transmitted to the audio/video switching or mixing device, via one or more HDMI cables.

In some implementations, the plurality of media signals is converted (908) into a mixed digital media signal. In some implementations, the plurality of media signals is first converted (910) into a mixed digital media signal using the sounder mixer 114, or an AN conversion device; the mixed digital media signals are then transmitted (912) to a high definition video streamer (e.g., the streamer 116 in FIG. 1A or the live HD video streamer 208 in FIG. 2A) through a high definition serial digital interface. Converting analog signals to digital signals is advantageous: Digital signals are less susceptible to noise or interference than analogy signals.

In some implementations, the mixed digital media signal outputted by the high definition video streamer is then transmitted (914), using a network protocol (e.g., an HTTP protocol), through a satellite uplink device (e.g., a mobile VSAT), to a satellite for distribution to a plurality of client devices. In some implementations, the mixed digital media signal is transmitted to the satellite uplink device using a radio frequency connection (916).

In some implementations, the mixed digital media signal is encoded, either before or after the transmission, using (i) a first video codec at each of a plurality of bitrates and (ii) a first audio codec, into a first plurality of bitrate streams.

In some implementations, each bitrate stream in the first plurality of bitrate streams comprises the video portion of the one or more digital media signals encoded at a corresponding bitrate in the first plurality of bitrates by the first video codec.

In some implementations, the first plurality of bitrate streams is stored in a video container (918). In some implementations, the video container is in MPEG-2, MP4, 3GP, or 3G2 format (920). In some implementations, the video container is in advanced systems format, the first video codec is a windows media video codec and the first audio codec is a windows media audio codec (922), e.g., so as to enable the video to be displayed in a MICROSOFT media player. In other implementations, the first video codec is H.264 (924).

In some implementations, the first plurality of bitrate streams is configured for adaptive bitrate streaming (926), and the first plurality of bitrate streams of the live event is downloaded (928); and delivered (930) to a plurality of client devices using an adaptive bitrate streaming protocol.

In some implementations, by using adaptive bitrate streaming protocol, quality of the bitrate streams (e.g., video streams) delivered to a client device is determined or adjusted, in accordance with a client device's bandwidth and processing power (e.g., CPU capacity) in real time). In some implementations, an adaptive encoder is use to encode mixed signals at various bit rates, depending on an amount of resources available at real time at a client device. For example, high quality video streams are delivered to a client device equipped with sufficient processing power and a broadband connection, to take advantage of the amble processing and connection capacity; however, lower quality video streams may be delivered to the same client device, when more than half of the client device's processing and connection capacity is used by other applications or opening threads. In some implementations, the use of adaptive bitrate stream protocol is advantageous, because it may reduce buffering and wait time associated therewith, and maintain quality viewing experience for both high-end and low-end connections. In some implementations, the adaptive bitrate streaming protocol is ADOBE dynamic streaming for FLASH or APPLE HTTP adaptive streaming (932).

In some implementations, each bitrate stream in the first plurality of bitrate streams comprises the video portion of the one or more digital media signals encoded at a corresponding bitrate in the first plurality of bitrates by the first video codec (934). In some implementations, the first video codec is H.264, and the first audio codec is ACC (938).

In some implementations, a client device in the plurality of client devices is a tablet computer, a smart phone, a desktop computer, a laptop commuter, a TV, or a portable media player (940).

FIG. 1B illustrates essentially what is described above with respect to FIG. 1A except that it additionally illustrates that in some implementations, a user device 124 communicates via a wireless connection (e.g. wifi, bluetooth, radio or infrared) to the plurality of video cameras 202-1 to 202-n. A respective video camera 202-n provides both a high quality/high definition video feed 105 (used for distribution of the live event to client devices 108-a through 108-n and also a video) and a potentially lower quality video used to providing a real time wireless transmission of the respective camera's view of the live event 101 to the user device 124. In some implementations, the user device 124, is an iPad, cell phone with video display, laptop computer, or a similar device. A user, such as an event director, is thus capable of viewing various camera views of the live event on the user device 124 (often simultaneously), and then the director can select and direct movement of one or more of the cameras in real time during the event in order to get the artistic view and mixture of views preferred by the director. For example, the director may instruct one camera to zoom in on a particular band member and direct another camera to pan the crowd attending the live event. In some implementations, the cameras 202-1 to 202-n are also able to communicate with each other in order to determine whether more than one camera is providing video of the identical view. In this implementation, a first video camera can communicate a warning to the user device 124 and suggest a change in orientation for the first video camera. The quality warning is indicative of a condition that is resolvable by a change in orientation of the first video camera.

FIG. 2B illustrates essentially what is described above with respect to FIG. 2A except that it additionally illustrates that in addition to receiving high quality/high definition video 105 from the cameras 202-1 to 2020-n, and controlling the control device (and thus the operation of the live HD video/audio streamer 208), a user (such as the director in charge of broadcasting the live event) also has the ability to wirelessly control the positioning and/or orientation of the video cameras 202-1-202-n capturing video of the live event by means of the user device 124. In some embodiments, the high quality video 105 is defined as the video obtained from the HD video/audio streamer 208, as digital signals, via a high definition serial digital interface (“HD-SDI”) connection 206, a HDMI connection, or a cable connection as explained with respect to FIG. 2A. The user device 124 receives wireless transmissions of the videos 125 from the cameras 202-1 to 202-n, and can review the views from the cameras 202-1 to 202-n, select a respective camera and control its positioning and/or orientation.

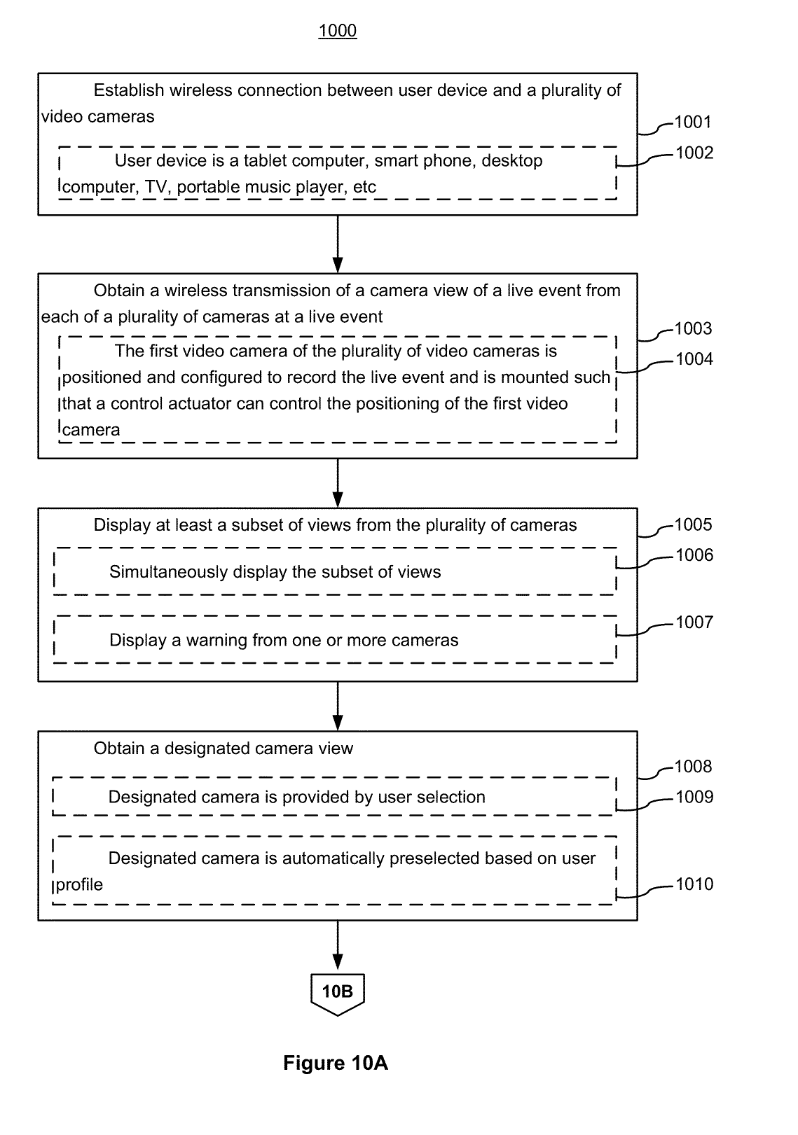

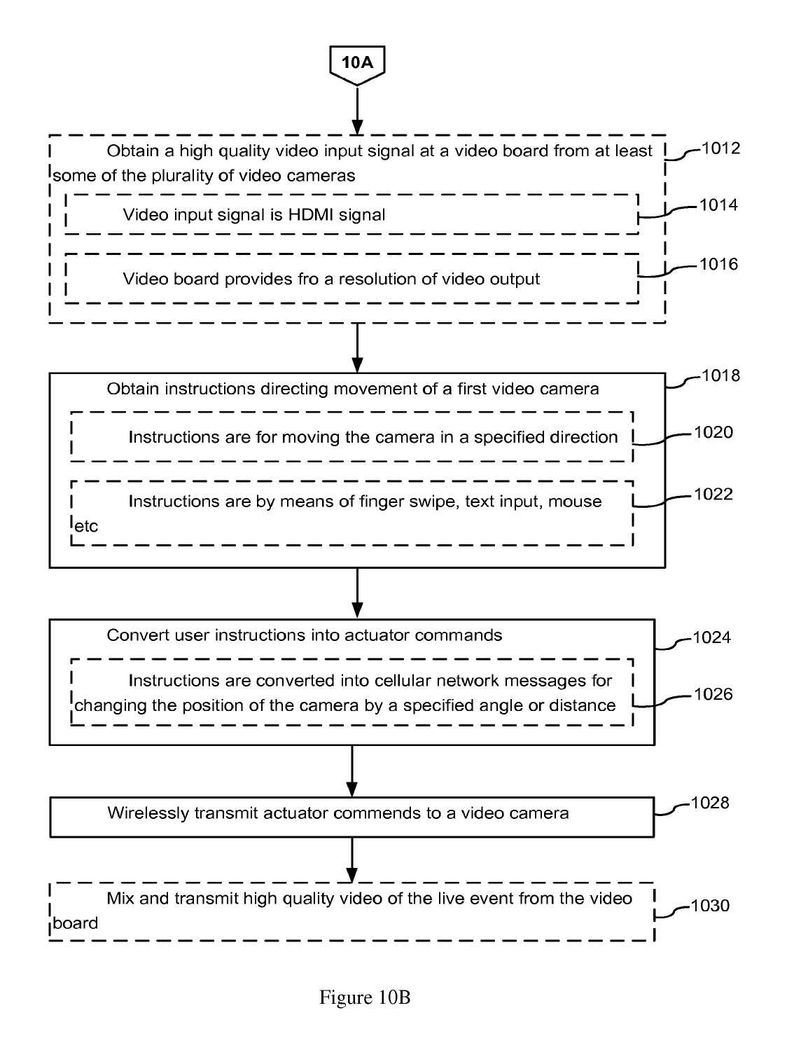

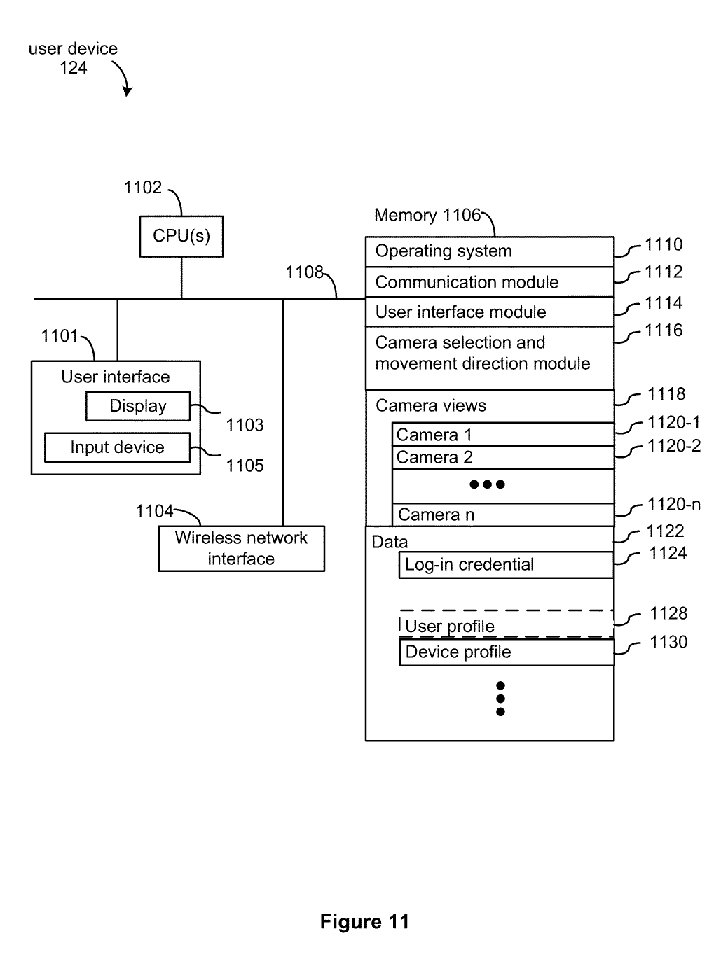

FIGS. 10A-10B are flowcharts representing a method (1000) for remotely controlling cameras at a live event, according to certain some embodiments. The method (1000) is typically governed by instructions that are stored in a computer readable storage medium and that are executed by one or more processors of one or more computers. Each of the operations shown in FIGS. 10A-B typically corresponds to instructions stored in a computer memory or non-transitory computer readable storage medium. The computer readable storage medium typically includes a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. Specifically many of the operations shown in FIGS. 10A-10B correspond to instructions in the camera selection and movement direction module 1116 of the user device 124 shown in FIG. 11.

In one aspect of the present disclosure, a method (1000) of controlling cameras at a live event proceeds as follows. A wireless connection between a user device and a plurality of video cameras is established 1001. In some embodiments, the user device, is a Director's iPad, cell phone with video display, laptop computer, or a similar device with a wireless communication capability 1002.

A wireless transmission of a camera view of a live event is obtained from each of a plurality of video cameras at the live event 1003. Each camera is positioned and configured to record the live event and is mounted such that a control actuator can control the orientation of the video camera 1004. In some embodiments, the user device implements Internet Explorer 9.0 or greater, SAFARI 3.0 or greater or ANDROID 2.0 or greater 1012.

At least some views from the cameras are displayed on the user device 1005. In some embodiments, all of the subset of views are concurrently displayed in a plurality of panels 1006. In other embodiments, the displayed views change periodically. For example, in some embodiments, twelve views are displayed concurrently, and if more than twelve cameras are providing views, then the camera views displayed change periodically such that the each camera's view is displayed periodically.

In some embodiments, the first video camera identifies a quality warning, communicates this warning to the user device and suggests a change of position or orientation of the first video camera 1007. For example, if a first video camera determines that its view shows only darkness, the first camera may identify that it is being blocked. The first video camera can then communicate a warning and suggest a change in position to the user device. In other embodiments, when the first video camera is positioned or oriented such that it captures a view identical to a second video camera, the first video camera communicates with the user device suggesting a position or orientation change of the first video camera to capture a different view. In this embodiment, each video camera in the plurality of video cameras is able to communicate with other video cameras in the plurality of video cameras.

In some embodiments, a designated camera view is obtained 1008. In some embodiments, a first video camera is selected by the user as the designated camera and this designated camera is highlighted in its panel 1009. In some embodiments, the user device is automatically able to determine which camera view is the user's designated view by accessing a user profile containing the user's preferences from a lookup table 1010. In some embodiments, the user's profile is configured based on the event venue, event type or the user's preferences. A user's profile may also be created based on instructions sent during a live event and saved to that user's profile for that event, event type or venue. In some embodiments, the selecting step, in which a video signal from among the plurality of cameras recording the live event is chosen, comprises displaying a plurality of panels on a touch-screen display, where each respective panel in the plurality of panels displays a respective video input signal received by a corresponding video input in the plurality of video inputs, and receiving a selection of a first panel in the plurality of panels, thereby selecting the video input signal displayed by the first panel.

In some embodiments a video board receives high quality input signals from a plurality of video cameras 1012. In some embodiments, the high input signals include high quality video (105 FIG. 1), which is video obtained from the HD video/audio streamer 208, as digital signals, via a high definition serial digital interface (“HD-SDI”) connection 206, a HDMI connection, or a cable connection as explained with respect to FIG. 2A. The video input signal from a respective video camera comprises an HDMI signal that is converted to a video serial digital interface signal prior to input into the video board 1014. The video board provides for a resolution of the video output from the video board 1016, which are in some embodiments set to one of a plurality of predetermined resolutions which can include 1920x1080i 60, 1920x1080i 59.94, 1920x1080i 50, 1280×720p 60, 1280×720p 59.94 and 1280×720p 50.

The user device obtains the user's instructions for moving a first video camera 1018. In some embodiments, the instructions are for moving the first video camera in a specified direction 1020. In some embodiments, these instructions are communicated to the user device with a swipe of the user's finger 1022. In other embodiments, the user's instructions are communicated to the user device as a text input or with the user interacting with the user device's touch screen 1022. The user's instructions are converted into one or more actuator commands 1024. An actuator command may include a command to change orientation by a first angle in the plurality of angles in vertical plane, a command to change orientation by a first angle in the plurality of angles in horizontal plane. Other commands to change the view of the camera are also possible. For example user instructions may be converted into a command to change position by a first distance in the plurality of distances in the vertical plane, a command to change position by a first distance in the plurality of distances in horizontal plane, a command to change position by a first distance in the plurality of distances forward or backward relative to the starting position of first video camera, and a command to zoom in or out from a current view 1026.

The actuator commands are then wirelessly transmitted to the camera 1028. In some embodiments, the actuator commands are packetized prior to wireless transmitting. In some embodiments, actuator commands are transmitted over a cellular network to the first camera. In some embodiments, the actuator commands are transmitted using an 802.11 protocol to the first camera. In some embodiments, the user's instructions are encoded and packaged as Short Message Service (SMS) messages and wirelessly transmitted using a cellular network to the first video camera for changing the camera view of the live event of the first video camera. In some embodiments, the cellular network is a 2G, 3G or 4G cellular network. Then the video camera's control actuator orients the first video camera in accordance with the commands.

The new view of the video camera is then transmitted both wirelessly to the user device and also the high quality video input signal is transmitted to the video board. Mechanisms described elsewhere in this application are used to mix and transmit the high quality views of the live event to users 1030.

FIG. 11 is a block diagram illustrating a user device, in accordance with some implementations. The user device 124, in some implementations, includes a user interface 1101, one or more processing units CPU(s) 1102 (also herein referred to as processors), one or more wireless network interfaces 1104, memory 1106, and one or more communication buses 1108 for interconnecting these components. The user interface 1101 includes a display 1103 (e.g., a LCD or a touchscreen), and an input device 1105 (e.g., a keyboard, a mouse, a touchpad, or a touchscreen). The communication buses 1108 optionally include circuitry (sometimes called a chipset) that interconnects and controls communications between system components. The memory 1106 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 1106 optionally includes one or more storage devices remotely located from the CPU(s) 1102. The memory 1106, or alternatively the non-volatile memory device(s) within the memory 1106, comprises a non-transitory computer readable storage medium. In some implementations, the memory 1106 or alternatively the non-transitory computer readable storage medium stores the following programs, modules and data structures, or a subset thereof:
an operating system 1110, which includes procedures for handling various basic system services and for performing hardware dependent tasks;
a network communication module (or instructions) 1112 for connecting the user device 124 with other devices (e.g., the cameras 202-1 to 202-n) via one or more wireless network interfaces 1104 (wired or wireless);
a user interface module 1114 for enabling a user, such as an artistic director, to interact with the user device (e.g., to select a camera and instruct it to move);
a camera selection and movement interface module 1116 for processing a plurality wireless transmissions of camera views from a plurality of cameras, preparing the views for display on the display 103 (sometimes all concurrently), and for receiving selection and movement instruction from a user on the input device 1105, and converting the instruction into actuator commands, and preparing the commands for wireless transmission over the wireless network interface;
a camera views storage 1118, stored on the user device 124, which includes:
   camera 1 view 1120-1, camera 2 view 1120-2 to camera n view 1120-n; and
optional data 1122, stored on the user device 124, which include:
   log-in credential 1124 for authenticating a user of (e.g., logging into) the user device;
   optionally, a user profile 1128 for including, with express user permission, user details such as preferred default camera views for one or more venues; and
   a device profile 1130 for including user device configuration information (e.g., display resolutions supported or enabled, graphical or general processing power equipped, operating system version, or memory capacity).

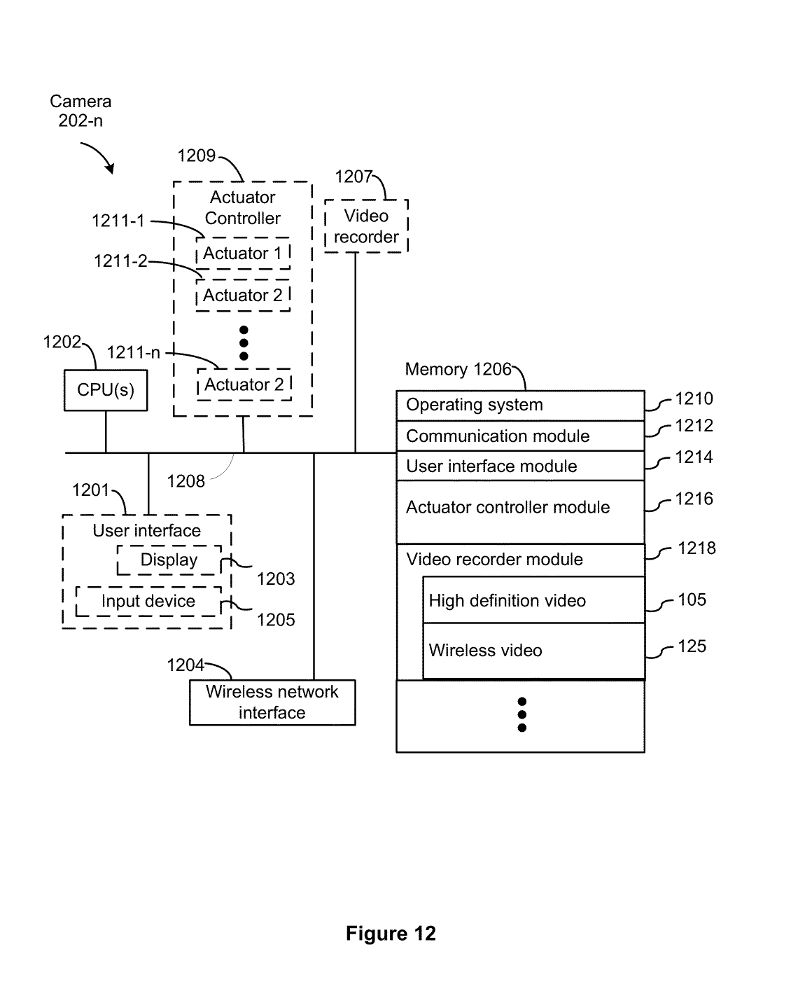

FIG. 12 is a block diagram illustrating a camera, in accordance with some implementations. The camera 202-n, in some implementations includes one or more processing units CPU(s) 1202 (also herein referred to as processors), one or more wireless network interfaces 1204, memory 1206, and one or more communication buses 1208 for interconnecting these components. The camera optionally includes a user interface 1201, with a display 1203 (e.g., a LCD or a touchscreen), and an input device 1205 (e.g., a keyboard, a mouse, a touchpad, or a touchscreen) for optional manual control or set up but the user display and input devices are not used in the preferred implementations of moving the camera described herein. A video recorder 1207 for recording video of a live event. An actuator controller 1209 for controlling the movement of a plurality of actuators 1211-1 to 1211-n, each configure to move the camera 202-n in one or more dimensions. Typically one or more actuators are configured to change one or more orientations of the camera. In some embodiments, actuators 1211-n include motion control systems such as a Stepper Motor, a Linear Step Motor, a DC Brush, Brushless, a Servo, a Brushless Servo and the like. In some preferred embodiments, an actuator 1211-n is a step motor. A step motor is typically an electromagnetic device that converts digital pulses into mechanical shaft rotation. In most cases the step motor consists of an indexer/controller capable of generating step pulses and directions signals for a driver. The driver/amplifier converts the indexer commands into power to energize the step motor's motor windings. Various different current/amperage ratings of the driver/amplifier are possible depending on the embodiment. In some embodiments, the actuator 1211-n is a variable reluctance step motor, a permanent magnet step motor, or a hybrid step motor. In some embodiments, the actuator 1211-n is a unipolar step motor, an R/L step motor, or a bipolar chopper step motor. In some embodiments, the control actuator is an electrical actuator or a magnetic actuator. The communication buses 1208 optionally include circuitry (sometimes called a chipset) that interconnects and controls communications between system components. The memory 1206 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 1206 optionally includes one or more storage devices remotely located from the CPU(s) 1202. The memory 1206, or alternatively the non-volatile memory device(s) within the memory 1206, comprises a non-transitory computer readable storage medium. In some implementations, the memory 1206 or alternatively the non-transitory computer readable storage medium stores the following programs, modules and data structures, or a subset thereof:
an operating system 1210, which includes procedures for handling various basic system services and for performing hardware dependent tasks;
a network communication module (or instructions) 1212 for connecting the camera 202-n with other devices (e.g., the user device 124) via one or more wireless network interfaces 1204 (wired or wireless);
an optional user interface module 1214 for enabling a user, to manually to interact with the camera 202-n (e.g., for set up or control);
an actuator controller module 1216 for controlling the actuator controller 1209 by receiving actuator commands from the user device 124 and transmitting the commands to the one or more actuators 1211-1 to 1211-n; and
a video recorder module 1218, for receiving the video recorded by the video recorder 1207 and transmitting high definition video 105 to the signal processing system (102 FIG. 1A) and transmitting wireless enabled video 125 to the user device (124 FIG. 11).

Although FIGS. 11 and 12 show a “user device 124” and a “camera 202-n,” respectively, FIGS. 11 and 12 are intended more as functional description of the various features which may be present in system for controlling cameras at a live event. These figures are meant to provide a structural schematic of the implementations described herein. In practice, and as recognized by those of ordinary skill in the art, items shown separately could be combined and some items could be separated.

In some implementations, one or more of the above identified elements are stored in one or more of the previously mentioned memory devices and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memories 1106 and 1206 optionally store a subset of the modules and data structures identified above. Furthermore, the memories 1106 and 1206 optionally store additional modules and data structures not described above.

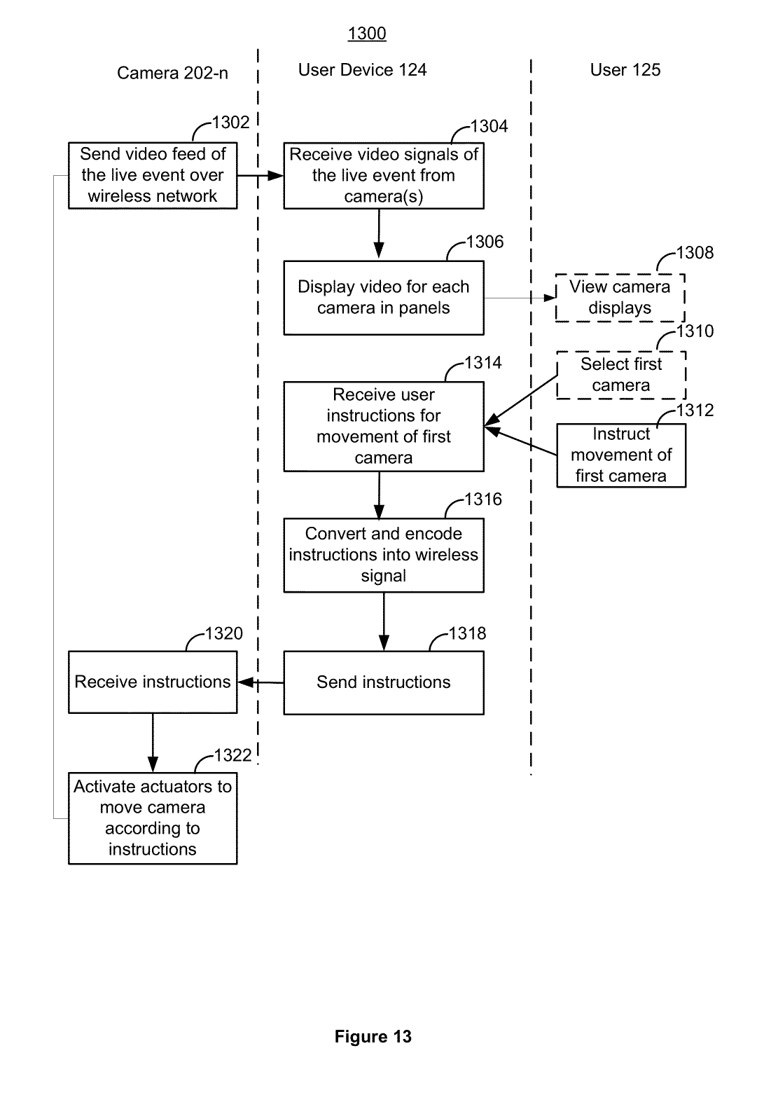

FIG. 13 is high level a flow chart illustrating a method for wirelessly controlling cameras at a live event, in accordance with some illustrations. This figure is indented to provide an overview of how the components and the user interact together to move a camera. More details about the steps shown herein are provides in FIGS. 10A and 10B.

A camera 202-n, records video of a live event, and sends a wireless quality version of the video 125 to a user device 124. The user device 124 is often used by an artistic director of a live event to monitor and control the movement of a plurality of video cameras recording a live event. This user device 124 is often a separate device from the signal processing system, which may include a video board receiving high quality video. The director uses the high quality to be used by the artistic director to mix and produce a live signal which is provided to viewers of the live event on client devices 108-n, whereas the director uses the video on the user device to easily and intuitively direct movement of the cameras recording the live event.

The user device 124 receives the views from a plurality of cameras 1304. The user device 124 displays a least a subset of the views on a display screen. In some embodiments all of the camera views are displayed simultaneously/concurrently so that the user can quickly and easily assess all of the cameras and make a determination about which cameras are providing good views of the event and which cameras should be moved.

The user 125 views the camera displays 1308. The user can optionally select a designated first video camera 1310. This is considered an optional step because the camera may already be pre-selected as the designated view. The user 125 then instructs the first camera to move 1312. The instruction can be by means of touch screen interaction or other means.

The user device 124 receives instructions for movement of the first video camera 1214. The user device converts and encodes the user instructions into one or more actuator commands on a wireless signal 1316. Then the user device transmits the wireless signal to the appropriate camera 1318.

The camera 202-n receives the instructions 1320, and utilizes an actuator controller module to activate one more of the actuators to move the camera according to the instructions 1322. It is noted that the instructions may alternatively or additionally include instructions to transition from one designated camera to another. For example, this may involve transitioning between (i) a default video camera preselected as a default designated camera and (ii) the first video camera in response to the user selection of the first camera as the designated camera.

The process repeats in that the camera continues to record the live event and sends the video feed of the live event to the user device via the wireless network, thus providing the user 125 with real time feedback regarding the new position/orientation of the camera and the new views now captured. As such the user (such as the artistic director) can in real time remotely control numerous camera views. This allows the artistic director to capture the essence and experience of the live event in order to mix various views to distribute a high quality feed of the live event via satellite for remote viewers watching via their own client devices.

As such, in accordance with the above described method, a user, such as an artistic director, can direct the movement of video camera at a live event to produce an artistic rendering of a live event for transmission to remote client devices (108-1 to 108-n, FIG. 1). The director can quickly and easily remotely control movement of the cameras using finger swipes and other intuitive means to direct the cameras. The messages are sent to the cameras, which are outfitted to receive instructions through wireless communications means. The cameras are outfitted with actuators to interpret the instructions automatically and move in the specified ways, with the need of human intervention. Thus, various views of the live concert can be captured in real time and provided to remote viewers. For example, if a performer goes off script and walks into the audience to interact with audience members, the director can quickly and easily capture this interaction from a variety of cameras, choose the best angle, mix and transmit this experience to viewers participating remotely in the live concert by receiving the data on their client devices.

### Cloud Based Implementations

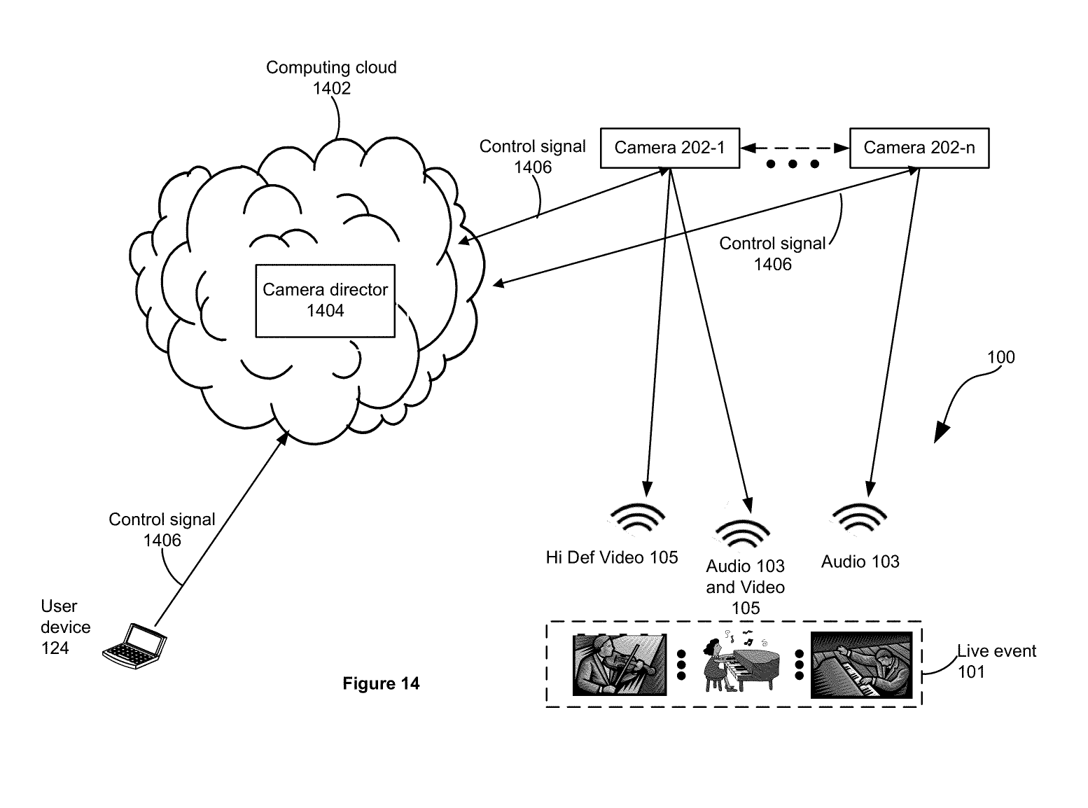

FIG. 14 is a block diagram illustrating a system for remotely controlling video camera using a computing cloud, in accordance with some implementations.

In some implementations, a computing cloud is used to remotely control video cameras and video/audio production at a live event.

For example, a camera director (or video director) 1404 is placed in (connected to) a computing cloud (e.g., an AMAZON cloud, or an IBM cloud). The video director 1404 is connected with a user device 124 and with cameras 202-1 . . . 202-n.

In some implementations, a user (e.g., a broadcasting director) sends control signals 1406 to the camera director 1404 residing in the computing cloud 1402, which in turn relays the control signals 1406 to the cameras 202-1 . . . 202-n placed at a live event.

In another example, a broadcasting director, seeing that the camera 202-1 is pointing at upper left corner of the center stage, would like to repoint the camera 202-1 to the lower right corner of the center stage. The broadcasting director transmits, via a user application (e.g., an IPHONE application or a remote control application), control signals to the computing cloud 1402 (or to the camera director 1404 resident therein).

After receiving the control signals 1406, the camera director 1404 sends these control signals to the camera 202-1, thereby repointing the camera 202-1 from the upper left corner of the center stage to the lower right corner of the center stage. The user device 124 can similarly control the camera 202-n.

In some implementations, cameras are controlled by the camera director 1404 automatically without human intervention, e.g., using voice/image recognition techniques.

For example, using image recognition techniques, the camera director 1404 analyzes the Hi Def Video signals 105 (or a still image therein) captured using the camera 202-1, and determines that no human faces are presently captured (despite that the camera 202-1 is supposed to point at front row audience). Upon this determination, the camera director 1404 generates and sends control signals to the camera 202-1, so as to adjust camera 202-1's position to point at front row audience. In some implementations, video signals are periodically (e.g., every 2 minutes) monitored by the camera director (e.g., using image recognition techniques), so as to ensure camera performance.

In another example, using voice recognition techniques, the camera director 1404 analyzes the audio signals 103 (or a portion thereof) captured using the camera 202-n, and determines that the audio signals 103 includes a higher than predefined level of noise, which suggests that audio collecting unit (e.g., a microphone) on the camera 202-n is not directly facing a sound source (e.g., a pianist), e.g., after a member of the audience accidentally pushed the camera to its left. Upon this determination, the camera director 1404 generates and sends control signals to the camera 202-n, so as to adjust the camera 202-1 to more directly facing the sound source (e.g., the pianist). In some implementations, audio signals are periodically (e.g., every 2 minutes) monitored by the camera director (e.g., using audio analysis techniques), so as to ensure camera performance.

These methods are technically advantageous. Because the use of computing cloud allows a broadcasting director (e.g., an audio/video director) to be present at a location other than where the live event is taking place, thereby increasing system flexibility.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method of controlling a plurality of cameras at a live event comprising:
on a user device having one or more processors and memory storing one or more programs for execution by the one or more processors:
obtaining a wireless transmission of a camera view of a live event from each camera of the plurality of video cameras at the live event;
displaying at least a subset of views from the plurality of cameras on the user device;
obtaining a user instruction directing movement of a first video camera of the plurality of cameras;
converting the user instruction into one or more actuator commands; and
wirelessly transmitting the one or more actuator commands to the first video camera for changing the camera view of the live event of the first video camera.

2. The method of claim 1, further comprising:
prior to obtaining the wireless transmission, establishing a wireless connection between the user device and the first video camera.

3. The method of claim 1, wherein the first video camera is positioned and configured to record the live event and is mounted such that a control actuator can control the orientation of the first video camera.

4. The method of claim 1, wherein the displaying comprises:
concurrently displaying a plurality of panels, wherein each respective panel in the plurality of panels displays a corresponding view of the subset of views from the plurality of video cameras.

5. The method of claim 1, further comprising:
prior to obtaining the user instruction directing movement of the first video camera, obtaining a user selection of the first camera as a designated camera.

6. The method of claim 1, further comprising:
obtaining communication from the first video camera that is directed to the user device, wherein first video camera identifies a quality warning indicative of a condition that is resolvable by a change of orientation of the first video camera.

7. The method of claim 1, wherein a designated camera view for at least one camera in the plurality of cameras is predetermined based on a user profile.

8. The method of claim 7, wherein the user profile is configured based on event venue, event type or one or more user preferences.

9. The method of claim 7, wherein the user profile is accessed from a lookup table.

10. The method of claim 5, further comprising:
transitioning between (i) a default video camera preselected as a default designated camera and (ii) the first video camera in response to the user selection of the first camera as the designated camera.

11. The method of claim 3, wherein the control actuator is a step motor.

12. The method of claim 11, wherein the step motor is a variable reluctance step motor, a permanent magnet step motor, or a hybrid step motor.

13. The method of claim 11, wherein the step motor is a unipolar step motor, an R/L step motor, or a bipolar chopper step motor.

14. The method of claim 3, wherein the control actuator is an electrical actuator or a magnetic actuator.

15. The method of claim 1, wherein the wireless transmission of a respective camera view is a video serial digital interface signal.

16. The method of claim 1, wherein the user device is a tablet computer, a smart phone, a desktop computer, a laptop computer, a TV or a portable media player.

17. The method claim 1, wherein when the first video camera is positioned such that it captures a view identical to a second video camera in the plurality of video cameras, and wherein the first video camera communicates with the user device suggesting an orientation change of first video camera to capture a different view.

18. The method of claim 1, wherein the one or more actuator commands to the first video camera includes a command to change orientation by a first angle in the plurality of angles in vertical plane.

19. The method of claim 1, wherein the one or more actuator commands to the first video camera includes a command to change orientation by a first angle in the plurality of angles in horizontal plane.

20. The method of claim 1, wherein the one or more actuator commands are transmitted over a cellular network or by an 802.11 protocol to the first camera.

21. The method of claim 1, further comprising modifying the camera view of the first video camera via a computing cloud.

22. The method of claim 1, further comprising: automatically, without human intervention, modifying the camera view of the first video camera via a computing cloud.

23. A user device, for controlling cameras at a live event, comprising:
one or more processors; and
memory storing one or more programs to be executed by the one or more processors;
the one or more programs comprising instructions for:
obtaining a wireless transmission of a camera view of a live event from each of a plurality of video cameras at the live event;
displaying at least a subset of views from the plurality of cameras on the user device;
obtaining a user instruction directing movement a first video camera of the plurality of cameras;
converting the user instruction into one or more actuator commands; and
wirelessly transmitting the one or more actuator commands to the first video camera for changing the camera view of the live event of the first video camera.

24. A non-transitory computer readable storage medium storing one or more programs configured for execution by a computer, the one or more programs comprising instructions for:
obtaining a wireless transmission of a camera view of a live event from each of a plurality of video cameras at the live event;
displaying at least a subset of views from the plurality of cameras on the user device;
obtaining a user instruction directing movement a first video camera of the plurality of cameras;
converting the user instruction into one or more actuator commands; and
wirelessly transmitting the one or more actuator commands to the first video camera for changing the camera view of the live event of the first video camera.
